(19) United States
(12) Patent Application Publication
(10) Pub. No.: US 2026/0254091 A1
(43) Pub. Date: Aug. 27, 2026

(54) UNIFORM ELECTRIC FIELD CAVITY DESIGN METHODS FOR SINGLE-MODE LIQUID MICROWAVE RESONANT CAVITY

(71) Applicant: OCEAN UNIVERSITY OF CHINA, Qingdao (CN)

(72) Inventors: Changhu XUE, Qingdao (CN); Qianqian XUE, Qingdao (CN); Donglei LUAN, Qingdao (CN); Hongying LIU, Qingdao (CN); Zhaojie LI, Qingdao (CN); Yunqi WEN, Qingdao (CN); Xiaoming JIANG, Qingdao (CN)

(73) Assignee: OCEAN UNIVERSITY OF CHINA, Qingdao (CN)

(21) Appl. No.: 19/433,140

(22) Filed: Dec. 26, 2025

(30) Foreign Application Priority Data
Feb. 22, 2025 (CN) 202510198243.9

(51) Int. Cl. H01P 11/00; H05B 6/64; H05B 6/80

(52) U.S. Cl. CPC H01P 11/002; H05B 6/6402; H05B 6/804

(57) ABSTRACT

Disclosed is a uniform electric field cavity design method for a single-mode liquid microwave resonant cavity, belonging to the technical field of microwave heating. The embodiments of the present disclosure start from dielectric properties of a liquid medium, and performs design of a numerical simulation model for the single-mode liquid microwave resonant cavity. The method includes: determining dielectric constants of the liquid medium by a cooling manner, and determining a thickness of a microwave resonant cavity; determining a length and a width of a simple model of the microwave resonant cavity through a parametric scan; introducing a tapered waveguide design to expand a microwave coverage range; and finally determining whether the single-mode liquid microwave resonant cavity is suitable for single-frequency microwave or band-frequency microwave through a frequency scan.

### CROSS-REFERENCE TO RELATED APPLICATIONS

This application claims priority to the Chinese Patent Application No. 202510198243.9, filed on Feb. 22, 2025, the entire contents of which are incorporated herein by reference.

### TECHNICAL FIELD

The present disclosure relates to the field of microwave heating technology, and in particular, to a uniform electric field cavity design method of a single-mode liquid microwave resonant cavity.

### BACKGROUND

A microwave field possesses invisibility and non-uniform heating characteristics, which severely limit its application in microwave technology. A single-mode resonant cavity offers unparalleled advantages over a multi-mode resonant cavity, including: a relatively stable heating pattern and a predictable heating mode. However, currently, there are few designs for the single-mode resonant cavity, and the distribution and uniformity of an electric field need to be improved. To further promote the application of microwaves in the industrial field, there is an urgent need to establish a manner that specifies an application process of a microwave resonant cavity. Current control schemes for microwave fields are mainly limited to the air domain, rather than a liquid microwave resonant cavity. Moreover, there are some imperfections in the design process of a single-mode liquid microwave resonant cavity in existing technology that require resolution.

Therefore, it is necessary to provide a uniform electric field cavity design method for a single-mode liquid microwave resonant cavity. The method may effectively determine cavity dimensions and constraints for an optimal resonant cavity for microwave energy-powered equipment at a specific frequency. The method improves the spatial distribution uniformity of a microwave electric field of the single-mode liquid microwave resonant cavity in the microwave resonant cavity, and provides technical support for subsequent utilization of microwave energy and the development of microwave equipment.

### SUMMARY

One or more embodiments of the present disclosure provide a uniform electric field cavity design method for a single-mode liquid microwave resonant cavity. The uniform electric field cavity design method includes: S1: determining a microwave frequency ƒ; S2: collecting dielectric constants of a liquid medium in an ƒ frequency band, wherein the ƒ frequency band is a frequency band range of the microwave frequency ƒ±20 MHZ, during the collecting, raising a temperature of the liquid medium to 95° C.±2° C. and allowing the temperature to naturally decrease over time, and recording a plurality of temperatures and dielectric constants and dielectric losses at the plurality of temperatures; S3: determining a wavelength of a microwave of the ƒ frequency band in the liquid medium according to a wavelength formula; S4: determining a thickness of a microwave resonant cavity according to the wavelength of the microwave in the liquid medium in S3; S5: selecting a specification of a rectangular waveguide according to the microwave frequency ƒ and GB/T 11450.2-1989; S6: establishing a simple model including only the rectangular waveguide, a microwave window, and the microwave resonant cavity; S7: performing a parametric scan on phases of an upper microwave source and a lower microwave source of the simple model, and analyzing a microwave electric field distribution in the microwave resonant cavity; S8: performing a parametric scan on a length and a width of the microwave resonant cavity and observing an electric field distribution and a reflection situation on an XY plane; S9: determining a waveguide wavelength λg at the microwave frequency ƒ based on formula (3), and adding a rectangular waveguide with height λg/2 to one side of the microwave resonant cavity, wherein a microwave in the microwave resonant cavity changes by half a phase cycle (2*π);

$${λ}_{{gTE}_{10}} = \frac{λ}{\sqrt{1 - {( \frac{λ}{2 a} )}^{2}}} ; \qquad ( 3 )$$

S10: introducing a tapered waveguide based on the simple model; and S11: performing a parametric scan on a microwave window length, a microwave window width, and a tapered waveguide height to complete an electric field cavity design.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary numerical simulation geometric model of a simplified model of a microwave resonant cavity according to some embodiments of the present disclosure;

FIGS. 2A-2C are schematic diagrams illustrating exemplary compositions of a simplified model of a microwave resonant cavity according to some embodiments of the present disclosure, where FIG. 2A is a rectangular waveguide, FIG. 2B is a microwave window, and FIG. 2C is a microwave resonant cavity (also referred to as a microwave heating cavity);

FIGS. 3A-3B are schematic diagrams illustrating an exemplary physical diagram and a numerical simulation geometric model of a tapered waveguide according to some embodiments of the present disclosure, where FIG. 3A is a physical tapered waveguide, and FIG. 3B is the numerical simulation geometric model of the tapered waveguide;

FIG. 4 is a schematic diagram illustrating an exemplary numerical simulation geometric model of a microwave heating module according to some embodiments of the present disclosure;

FIGS. 5A-5E are schematic diagrams illustrating exemplary compositions of a microwave heating module including a tapered waveguide according to some embodiments of the present disclosure, where FIG. 5A is a position of a rectangular waveguide, FIG. 5B is a position of a tapered waveguide, FIG. 5C is a position of a microwave window, FIG. 5D is a position of a microwave resonant cavity, and FIG. 5E is a position of a food;

FIGS. 6A-6B are schematic diagrams illustrating exemplary dielectric properties of a water medium at 433 MHz and 915 MHz measured using a falling temperature manner according to some embodiments of the present disclosure, where FIG. 6A is a dielectric constant, and FIG. 6B is a dielectric loss;

FIGS. 7A-7B are schematic diagrams illustrating exemplary dielectric properties of a water medium at 433 MHz and 915 MHz measured using a conventional temperature-rising manner according to some embodiments of the present disclosure, where FIG. 7A is a dielectric constant, and FIG. 7B is a dielectric loss;

FIGS. 8A-8C are schematic diagrams illustrating an exemplary influence of a phase difference of x between an upper microwave source and a lower microwave source of a 433 MHz microwave on an electric field distribution (heating mode) according to some embodiments of the present disclosure, where FIG. 8A is an electric field distribution in an XY plane, FIG. 8B is an electric field distribution in a YZ plane, and FIG. 8C is an electric field distribution in an XZ plane;

FIGS. 9A-9C are schematic diagrams illustrating an exemplary influence of a phase difference of 0 between an upper microwave source and a lower microwave source of a 433 MHz microwave on an electric field distribution (heating mode) according to some embodiments of the present disclosure, where FIG. 9A is an electric field distribution in an XY plane, FIG. 9B is an electric field distribution in a YZ plane, and FIG. 9C is an electric field distribution in an XZ plane;

FIGS. 10A-10C are schematic diagrams illustrating an exemplary influence of a phase difference of π/2 between an upper microwave source and a lower microwave source of a 433 MHz microwave on an electric field distribution (heating mode) according to some embodiments of the present disclosure, where FIG. 10A is an electric field distribution in an XY plane, FIG. 10B is an electric field distribution in a YZ plane, and FIG. 10C is an electric field distribution in an XZ plane;

FIGS. 11A-11C are schematic diagrams illustrating an exemplary electric field distribution when a 433 MHz microwave uses a BJ5 waveguide and a thickness of a microwave resonant cavity is 80 mm (89.14% of a wavelength) according to some embodiments of the present disclosure, where FIG. 11A is an electric field distribution in an XY plane, FIG. 11B is an electric field distribution in a YZ plane, and FIG. 11C is an electric field distribution in an XZ plane;

FIGS. 12A-12C are schematic diagrams illustrating an exemplary electric field distribution when a 433 MHz microwave uses a BJ5 waveguide and a thickness of a microwave resonant cavity is 107.7 mm (120% of a wavelength) according to some embodiments of the present disclosure, where FIG. 12A is an electric field distribution in an XY plane, FIG. 12B is an electric field distribution in a YZ plane, and FIG. 12C is an electric field distribution in an XZ plane;

FIGS. 13A-13C are schematic diagrams illustrating an exemplary electric field distribution when a 433 MHz microwave uses a BJ5 waveguide and a width of a microwave window is 1.0b according to some embodiments of the present disclosure, where FIG. 13A is an electric field distribution in an XY plane, FIG. 13B is an electric field distribution in a YZ plane, and FIG. 13C is an electric field distribution in an XZ plane;

FIGS. 14A-14C are schematic diagrams illustrating an exemplary electric field distribution when a 433 MHz microwave uses a BJ5 waveguide and a width of a microwave window is 0.5b according to some embodiments of the present disclosure, where FIG. 14A is an electric field distribution in an XY plane, FIG. 14B is an electric field distribution in a YZ plane, and FIG. 14C is an electric field distribution in an XZ plane;

FIGS. 15A-15C are schematic diagrams illustrating an exemplary electric field distribution when a 433 MHz microwave uses a BJ5 waveguide and a width of a microwave window is 1.2b according to some embodiments of the present disclosure, where FIG. 15A is an electric field distribution in an XY plane, FIG. 15B is an electric field distribution in a YZ plane, and FIG. 15C is an electric field distribution in an XZ plane;

FIG. 16 is a schematic diagram illustrating an exemplary variation of a reflection situation with a microwave frequency within a range of 433 MHZ±20 MHz according to some embodiments of the present disclosure, where a multi-excitation reflection coefficient component 1 is an upper microwave source, and a multi-excitation reflection coefficient component 2 is a lower microwave source;

FIG. 17 is a schematic diagram of an exemplary influence of a microwave frequency, within a range of 433 MHz±20 MHz, on an electric field distribution (heating mode) according to some embodiments of the present disclosure;

FIGS. 18A-18C are schematic diagrams illustrating an exemplary electric field distribution when a 915 MHz microwave uses a BJ8 waveguide and a thickness of a microwave resonant cavity is 40 mm (94.11% of a wavelength) according to some embodiments of the present disclosure, where FIG. 18A is an electric field distribution in an XY plane, FIG. 18B is an electric field distribution in a YZ plane, and FIG. 18C is an electric field distribution in an XZ plane;

FIGS. 19A-19C are schematic diagrams illustrating an exemplary electric field distribution when a 915 MHz microwave uses a BJ8 waveguide and a thickness of a microwave resonant cavity is 30 mm (71% of a wavelength) according to some embodiments of the present disclosure, where FIG. 19A is an electric field distribution in an XY plane, FIG. 19B is an electric field distribution in a YZ plane, and FIG. 19C is an electric field distribution in an XZ plane;

FIGS. 20A-20C are schematic diagrams illustrating an exemplary electric field distribution when a 915 MHz microwave uses a BJ8 waveguide and a thickness of a microwave resonant cavity is 47 mm (111% of a wavelength) according to some embodiments of the present disclosure, where FIG. 20A is an electric field distribution in an XY plane, FIG. 20B is an electric field distribution in a YZ plane, and FIG. 20C is an electric field distribution in an XZ plane;

FIGS. 21A-21C are schematic diagrams illustrating an exemplary electric field distribution when a 915 MHz microwave uses a BJ9 waveguide and a thickness of a microwave resonant cavity is 36 mm (84.59% of a wavelength) according to some embodiments of the present disclosure, where FIG. 21A is an electric field distribution in an XY plane, FIG. 21B is an electric field distribution in a YZ plane, and FIG. 21C is an electric field distribution in an XZ plane;

FIGS. 22A-22C are schematic diagrams illustrating an exemplary electric field distribution when a 915 MHz microwave uses a BJ9 waveguide and a thickness of a microwave resonant cavity is 30 mm (71% of a wavelength) according to some embodiments of the present disclosure, where FIG. 22A is an electric field distribution in an XY plane, FIG. 22B is an electric field distribution in a YZ plane, and FIG. 22C is an electric field distribution in an XZ plane;

FIGS. 23A-23C are schematic diagrams illustrating an exemplary electric field distribution when a 915 MHz microwave uses a BJ9 waveguide and a thickness of a microwave resonant cavity is 47 mm (111% of a wavelength) according to some embodiments of the present disclosure, where FIG. 23A is an electric field distribution in an XY plane, FIG. 23B is an electric field distribution in a YZ plane, and FIG. 23C is an electric field distribution in an XZ plane;

FIGS. 24A-24C are schematic diagrams illustrating an exemplary influence of a thickness of a microwave resonant cavity of 14 mm (88% of a wavelength) on an electric field distribution when a 2450 MHz microwave uses a BJ22 waveguide according to some embodiments of the present disclosure, where FIG. 24A is an electric field distribution in an XY plane, FIG. 24B is an electric field distribution in a YZ plane, and FIG. 24C is an electric field distribution in an XZ plane;

FIGS. 25A-25C are schematic diagrams illustrating an exemplary influence of a thickness of a microwave resonant cavity of 17 mm (106% of a wavelength) on an electric field distribution when a 2450 MHz microwave uses a BJ22 waveguide according to some embodiments of the present disclosure, where FIG. 25A is an electric field distribution in an XY plane, FIG. 25B is an electric field distribution in a YZ plane, and FIG. 25C is an electric field distribution in an XZ plane;

FIGS. 26A-26C are schematic diagrams illustrating an exemplary influence of a thickness of a microwave resonant cavity of 14 mm (88% of a wavelength) on an electric field distribution when a 2450 MHz microwave uses a BJ26 waveguide according to some embodiments of the present disclosure, where FIG. 26A is an electric field distribution in an XY plane, FIG. 26B is an electric field distribution in a YZ plane, and FIG. 26C is an electric field distribution in an XZ plane; and

FIGS. 27A-27C are schematic diagrams illustrating an exemplary influence of a thickness of a microwave resonant cavity of 17.5 mm (110% of a wavelength) on an electric field distribution when a 2450 MHz microwave uses a BJ26 waveguide according to some embodiments of the present disclosure, where FIG. 27A is an electric field distribution in an XY plane, FIG. 27B is an electric field distribution in a YZ plane, and FIG. 27C is an electric field distribution in an XZ plane.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

### Embodiments 1

In some embodiments of the present disclosure, a uniform electric field cavity design method for a single-mode liquid microwave resonant cavity (hereinafter referred to as “the method”) is provided. The method includes the following operations S1-S12:

In S1: A microwave frequency ƒ is determined.

In some embodiments, the microwave frequency ƒ may be 433 MHz or 915 MHz.

In some embodiments, determining the microwave frequency ƒ may be achieved by selecting a microwave frequency band commonly used in specific industrial or scientific applications. For example, for industrial microwave heating or scientific experiments, an ISM (Industrial, Scientific, and Medical) frequency band such as 433 MHz or 915 MHz may be selected as the microwave frequency ƒ. As another example, the microwave frequency ƒ may also be determined based on characteristics of a liquid medium to be processed, a required heating efficiency, or specific process requirements. For example, if a certain liquid absorbs microwave energy more efficiently at a specific frequency, and the specific frequency may be determined as the microwave frequency ƒ.

In S2: Dielectric constants of a liquid medium in an ƒ frequency band are collected. The ƒ frequency band is a frequency band range of the microwave frequency ƒ±20MHz. During the collecting, a temperature of the liquid medium is raised to approximately 95 ±2° C., and the temperature of the liquid medium is allowed to naturally decrease over time. A plurality of temperatures and the dielectric constants and dielectric losses at the plurality of temperatures are recorded.

The ƒ frequency band refers to an electromagnetic wave frequency range centered on the microwave frequency ƒ within a certain range (e.g., ±20 MHz). For example, when the microwave frequency ƒ is 433 MHz, the ƒ frequency band may be a range from 413 MHz to 453 MHz; when the microwave frequency ƒ is 915 MHz, the ƒ frequency band may be a range from 895 MHz to 935 MHz.

The liquid medium refers to a substance that is in a liquid state and has dielectric properties. For example, the liquid medium may be water (purified water, tap water and other water medium with different degrees of purification), oil (oils or water-oil mixtures with different compositions or properties), alcohol, a chemical solution, etc.

The dielectric constant refers to a physical quantity that measures an ability of a substance (e.g., the liquid medium) to store electrical energy in an electric field. The dielectric loss refers to a physical quantity that measures an ability of a substance (e.g., the liquid medium) to convert electrical energy into thermal energy in an alternating electric field.

In some embodiments, during the process of temperature decreasing in S2, the plurality of temperatures includes 90° C. For example, the plurality of temperatures includes one or more of 95° C., 90° C., 85° C., 80°° C., 75° C., 70° C., 65°° C., 60° C., 55°° C., 50° C., 45°° C., 40° C., 35° C., etc.

A natural process of temperature decreasing continuously passes through 90° C., enabling the dielectric constant and dielectric loss data at 90°° C. to be accurately captured and recorded.

According to some embodiments of the present disclosure, the accuracy of dielectric property data under high-temperature processing conditions commonly used in industrial applications is ensured by explicitly including the temperature point of 90° C. during the process of temperature decreasing of the liquid medium dielectric property collection.

In some embodiments, a falling temperature manner may be used for the process of collecting the dielectric constants and the dielectric losses of the liquid medium in the ƒ frequency band and increasing the temperatures of the liquid medium while recording relevant data.

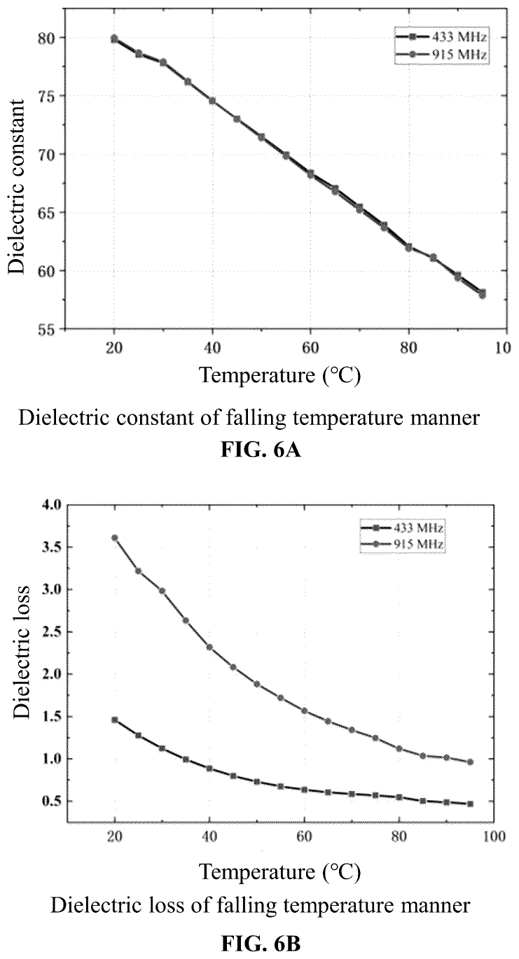

FIGS. 6A-6B are schematic diagrams illustrating exemplary dielectric properties of a water medium at 433 MHz and 915 MHz measured using a falling temperature manner according to some embodiments of the present disclosure, where FIG. 6A is a dielectric constant, and FIG. 6B is a dielectric loss.

In some embodiments, S2 includes the following operations S21-S25.

In S21: 500 mL of purified water is measured by using a beaker or other glass container. The container is covered with a sealing film to prevent water vapor loss due to temperature increase.

In S22: The container containing the purified water is placed in a heatable water bath. A temperature measurement device is placed in a middle and lower part of the purified water. For example, the temperature measurement device may include a temperature measurement probe, an optical fiber, etc.

In S23: Calibration is performed by using a vector network analyzer equipped with a dielectric property measurement probe. A calibrated instrument is obtained using air, a metal correction module, and 25° C. deionized water in sequence. In some embodiments, the vector network analyzer may include network analyzers such as E5071C, 8417E, etc. The dielectric property measurement probe may include probes such as 85070B, N1501A, etc. The vector network analyzer includes the metal correction module. The metal correction module is configured to provide stable electromagnetic response characteristics to reduce system errors of the analyzer.

In S24: The temperature of the purified water is gradually increased to 95° C. The dielectric property measurement probe is placed into the purified water. Bubbles formed by the purified water at the dielectric property measurement probe are removed by using a gentle plastic rod that does not scratch the probe.

In S25: Heating the heatable water bath is stopped. The temperature of the purified water in the container is allowed to naturally decrease. A plurality of real-time temperature changes are recorded. The dielectric constants and the dielectric losses of the purified water in ranges of 413 MHz to 443 MHz and 895 MHz to 925 MHz are collected using the vector network analyzer and the dielectric property measurement probe. The plurality of temperatures are matched with the dielectric constants and the dielectric losses corresponding to the moments after heating is stopped.

In some embodiments, specific results measured using the falling temperature manner are shown in FIG. 6. FIG. 6A shows variations of the purified water with temperature. The dielectric constants and the dielectric losses at 433 MHz and 915 MHz change relatively stably and exhibit good regularity. This is consistent with related studies on the dielectric constant and the dielectric loss of water media. The dielectric constant decreases relatively stably and uniformly as the temperature increases. The dielectric loss gradually decreases as the temperature increases and gradually stabilizes as the temperature further increases.

In S3: A wavelength of the microwave in the ƒ frequency band in the liquid medium is determined according to a wavelength formula.

For example, a wavelength of the 433 MHz microwave in the purified water is 89.75 mm, and a wavelength of the 915 MHz microwave in the purified water is 42.56 mm.

In some embodiments, the wavelength formula includes a formula (1) and a formula (2)

When an electromagnetic wave enters a liquid medium from a vacuum medium, a velocity of the electromagnetic wave changes, while a frequency of the electromagnetic wave remains unchanged and a wavelength changes. Since the velocity v of the electromagnetic wave in the medium is 1\sqrt{ε′μ} of the velocity in vacuum, the velocity v of the electromagnetic wave may be represented by the formula (1):

$$v = \frac{c}{\sqrt{{ε}^{′} μ}} \qquad ( 1 )$$

Most foods are non-magnetic medium, and a relative permeability μ of non-magnetic media is approximately 1. Therefore, a refractive index in the food medium is obtained as n=\sqrt{ε}, and a corresponding velocity of the electromagnetic wave in the medium is

$$v = \frac{c}{\sqrt{ε}} ,$$

then the wavelength of the electromagnetic wave in the medium may be calculated by the formula (2):

$$λ = \frac{c}{f \sqrt{{ε}^{′}}} \qquad ( 2 )$$

where c is a light velocity of 3×10⁸ m/s; ƒ is the microwave frequency in Hz; ε′ is the dielectric constant; λ is the wavelength of the microwave in the liquid medium; μ is the relative permeability of the medium.

In S4: A thickness of a microwave resonant cavity is determined according to the wavelength of the microwave in the liquid medium in S3.

The microwave resonant cavity refers to a cavity configured to carry a liquid medium and form a microwave electric field therein to achieve resonance of a specific mode. For example, the microwave resonant cavity is a single-mode liquid microwave resonant cavity used to design a uniform electric field distribution. Geometric dimensions of the microwave resonant cavity, such as a thickness, a length, and a width, are determined according to the microwave frequency and dielectric properties of the liquid medium, and the microwave resonant cavity constitutes a microwave heating system together with components such as a rectangular waveguide and a microwave window.

According to a definition of a single-mode cavity, when one of the length, the width, and the height of the resonant cavity is less than the wavelength of the microwave in the medium within the cavity, a single-mode cavity is formed, which has a relatively stable electric field distribution and microwave heating mode. To facilitate microwave processing of materials by the microwave resonant cavity, a limiting factor of the resonant cavity of a general single-mode cavity is set as the thickness of the microwave resonant cavity. The thickness of the microwave resonant cavity is determined according to the calculation of the wavelength of the microwave in the liquid medium in S3. If the water quality is different, it may cause slight deviations in the wavelength of the microwave in different water qualities. Considering differences caused by the water quality, a maximum value of a thickness range is 95% of the wavelength. In addition, based on research results of electric field analysis in preliminary experiments and considerations of space and microwave energy utilization in mechanical design, a minimum value of the thickness of the microwave field is determined as 80% of the wavelength.

Therefore, in some embodiments, according to a formation principle of the single-mode cavity and an application scenario of the actual microwave resonant cavity, the thickness of the microwave resonant cavity in the ƒ frequency band is set as the limiting factor, and the thickness of the microwave resonant cavity is specified as the wavelength λ*(80%-95%), i.e., the thickness of the microwave resonant cavity may be specified as 80% to 95% of λ. For example, when the microwave frequency ƒ is 433 MHz, the wavelength λ determined according to S3 is approximately 89.75 mm, and the thickness of the microwave resonant cavity may be set to 71.80 mm-86.26 mm; when the microwave frequency ƒ is 915 MHz, the wavelength λ determined according to S3 is approximately 42.56 mm, and the thickness of the microwave resonant cavity may be set to 34.08 mm-40.32 mm.

In some embodiments, the thickness of the microwave resonant cavity is also specified as one of wavelength λ*(80%-95%), wavelength λ*(82%-95%), wavelength λ*(85%-95%), wavelength λ*(80%-92%), wavelength λ*(80%-90%), wavelength λ*(85%-90%), etc.

In some embodiments of the present disclosure, a single-mode operating state of the cavity is effectively ensured by precisely specifying the thickness of the microwave resonant cavity as 80% to 95% of the wavelength, thereby significantly improving the uniformity of the microwave electric field in the liquid medium and providing a reliable design basis for efficient and stable microwave heating applications.

In S5: A specification of the rectangular waveguide is selected according to the microwave frequency ƒ and GB/T 11450.2-1989.

The rectangular waveguide refers to a metal tube with a rectangular cross-section and is used to transmit microwave signals.

For example, a specification of the rectangular waveguide selected according to GB/T 11450.2-1989 for the microwave frequency ƒ of 433 MHz is BJ5, and a specification of the rectangular waveguide selected according to GB/T 11450.2-1989 for the microwave frequency ƒ of 915 MHz is BJ8 or BJ9.

GB/T 11450.2-1989 refers to hollow metallic waveguides part 2: relevant specifications for ordinary rectangular waveguides. GB/T 11450.2-1989 provides geometric dimensions and related electrical characteristics of standard rectangular waveguides at different frequencies. By consulting the GB/T 11450.2-1989, according to the determined microwave frequency ƒ, a corresponding specification of the rectangular waveguide that may effectively transmit microwave energy at this frequency and avoid the generation of parasitic modes may be found.

In S6: A simple model including only the rectangular waveguide, the microwave window, and the microwave resonant cavity is established.

The microwave window refers to a dielectric window used for coupling microwave energy into and out of the resonant cavity. The microwave window is typically made of a dielectric material to allow microwaves to pass through while maintaining the internal environment (e.g., the liquid medium) of the cavity sealed. A main function of the microwave window is to allow microwaves emitted by a microwave source to pass through after entering the rectangular waveguide, thereby entering the microwave resonant cavity, where a medium to be heated (e.g., food) is heated. Therefore, a dimension of the microwave window affects the electric field distribution in the heating cavity.

The simple model refers to a numerical simulation model that abstracts and simplifies an actual physical structure, including only key components (e.g., the rectangular waveguide, the microwave window, the microwave resonant cavity). The simple model may be a three-dimensional model, reflecting geometric shapes, relative positions, and connection relationships of the rectangular waveguide, the microwave window, and the microwave resonant cavity, and is used for preliminary analysis and optimization of the distribution of the microwave field.

In some embodiments, establishing the simple model may be accomplished using a professional electromagnetic simulation software (e.g., COMSOL Multiphysics). For example, according to the thickness of the microwave resonant cavity determined in S4 and the specification of the rectangular waveguide selected in S5, geometric structures of the rectangular waveguide, the microwave window, and the microwave resonant cavity are drawn in the simulation software, and then corresponding material properties are assigned to these components, e.g., metal (for the waveguide and cavity walls) and dielectric material (for the microwave window).

In some embodiments, construction manners of the simple model include a finite element method (FEM), a finite difference time domain method (FDTD), and a method of moments (MoM). For microwave heating problems, the FEM and the FDTD are two most widely used manners. Current simulation software is mainly divided into finite element software and finite-difference time-domain software. Commercial software such as Quickwave™ (QWED, Poland), Ansys (ANSYS, Pennsylvania, USA), and COMSOL Multiphysics (COMSOL multiphysics, Sweden) use the same manner to simulate heat transfer and Maxwell's equations, but the aforementioned software differ in the selection of numerical manners.

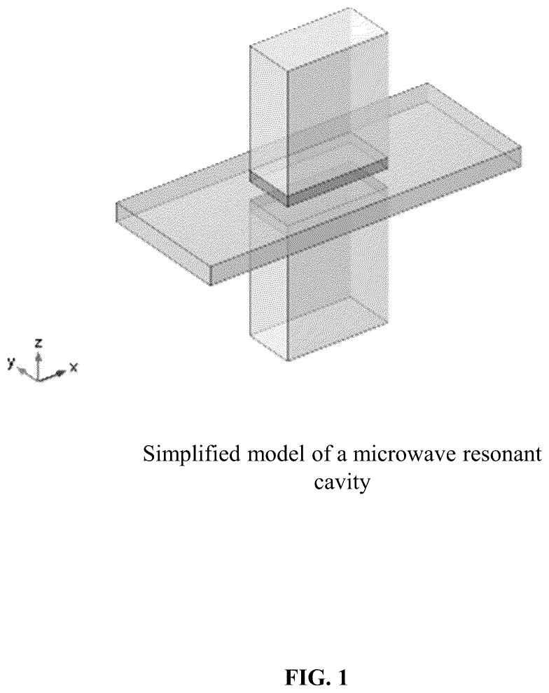

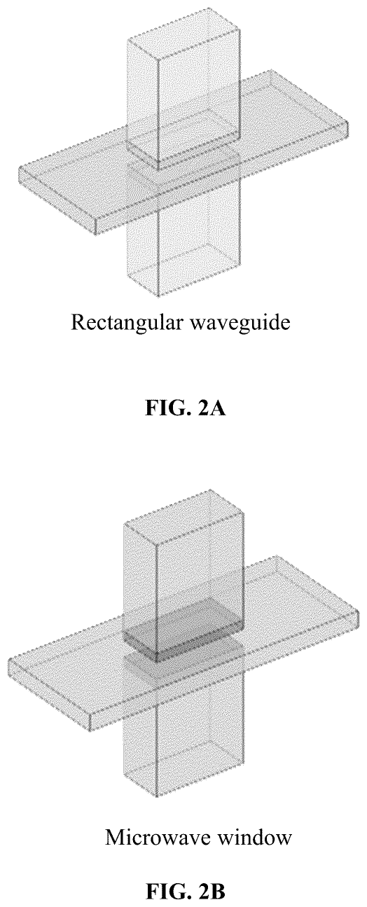

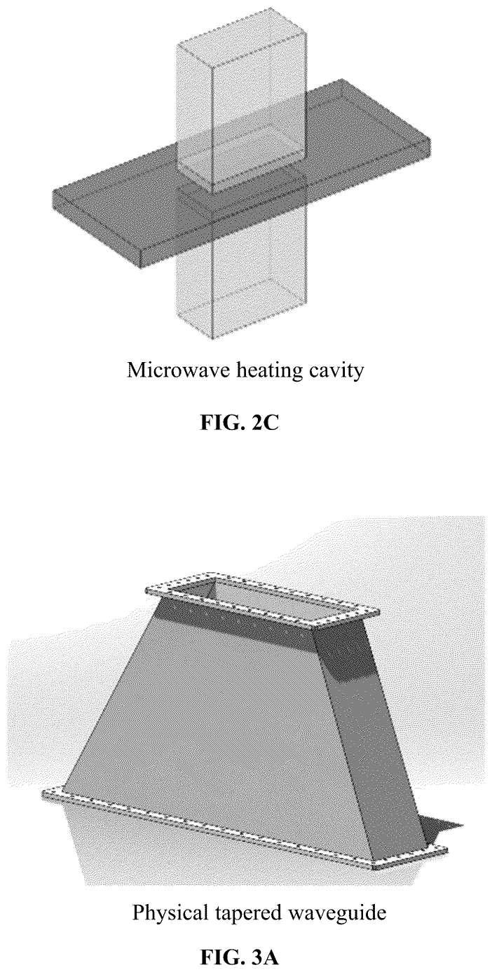

FIG. 1 is a schematic diagram illustrating an exemplary numerical simulation geometric model of a simplified model of a microwave resonant cavity (also referred to as a microwave heating cavity) according to some embodiments of the present disclosure. FIGS. 2A-2C are schematic diagrams illustrating exemplary compositions of a simplified model of a microwave resonant cavity according to some embodiments of the present disclosure, where FIG. 2A is a rectangular waveguide, FIG. 2B is a microwave window, and FIG. 2C is a microwave resonant cavity.

FIG. 2 shows the distribution positions of the rectangular waveguide, the microwave window, and the microwave heating cavity in the simple model. Under the distribution positions as shown in FIG. 2, a phase difference design of π may be implemented using a waveguide wavelength/2 to establish the simple model as shown in FIG. 1.

In S7: A parametric scan on phases of an upper microwave source and a lower microwave source of the simple model is performed, and a microwave electric field distribution in the microwave resonant cavity is analyzed.

The upper microwave source and the lower microwave source refer to two independent microwave energy input ports arranged on opposite sides (e.g., an upper side and a lower side) of the microwave resonant cavity. The phases of the upper microwave source and the lower microwave source refer to phase angles of the microwave energy fed from the upper microwave source and the lower microwave source.

The parametric scan refers to a process of performing automated and sequential simulations on the simple model based on at least one simulation parameter (e.g., a phase, a length of the microwave resonant cavity, a width of the microwave resonant cavity, etc.). An optimal combination of one or more model parameters may be obtained through the parametric scan.

For most microwave application scenarios, the electric field of the microwave should be distributed in a geometric center region of the microwave single-mode device, thereby facilitating placement or removal of the medium to be heated. Therefore, when determining the phase influence result, research on dispersion, concentration, and electric field strength of the microwave electric field should be primarily conducted.

A single-mode microwave device refers to a device that utilizes single-mode microwave energy and operates in a single mode to achieve specific functions. For example, the single-mode microwave device may include a microwave heating device for uniformly heating or processing a liquid medium. In some embodiments, the microwave resonant cavity is applied in the single-mode microwave device.

For example, the electromagnetic simulation software (e.g., COMSOL Multiphysics) may be used to visualize the electric field distribution in the resonant cavity, and intuitively determine the dispersion and concentration of the electric field. At the same time, numerical data of the electric field strength may be extracted to determine a root mean square value, a maximum value, a minimum value, and a standard deviation, thereby quantifying the dispersion, concentration, and strength of the electric field.

In some embodiments, determining the phase influence includes:

In S71: An initial phase is scanned, the initial phase is set as prot, with a range of 0-2π, and a scan step of π/4.

The initial phase refers to a phase angle set as a benchmark or reference. This operation ensures systematic traversal of all possible initial phases. For example, the electromagnetic simulation software automatically performs a simulation scan according to the range and the scan step. In some embodiments, a scan range and the scan step of the initial phase may also be adjusted according to specific requirements.

In S72: An upper phase is set as prot+prot_1, and a lower phase is set as prot. The prot_1 has a range of 0-2π, and a scan step size of π/4. The scan range of the lower phase prot is set to 0-2π.

In some embodiments, while scanning the initial phase prot, a relative phase difference is further introduced. The upper phase refers to a phase angle set for the upper side or the upper microwave source of the microwave resonant cavity. For example, the upper phase may be determined based on the initial phase prot and another relative phase prot_1, expressed as prot+prot_1. The lower phase refers to a phase angle set for the lower side or the lower microwave source of the microwave resonant cavity. For example, the lower phase may be directly set to the initial phase prot.

Since the upper and lower microwave sources in the simple model are completely symmetrically distributed, the phases of the upper and lower microwave sources are completely interchangeable and do not affect the result.

In some embodiments of the present disclosure, a dual parametric scan (initial phase prot and relative phase prot_1) is adopted, which may comprehensively and independently explore the influence of the phases of the upper and lower microwave sources on the electric field distribution in the resonant cavity, accurately identify an optimal phase combination, effectively avoid electric field hot spots or cold spots, ensure uniform distribution of microwave energy in the geometric center region of the single-mode microwave device, and greatly improve the heating efficiency and processing quality of the single-mode microwave device.

In S8: A parametric scan on a length and a width of the microwave resonant cavity is performed. The electric field distribution and a reflection situation on an XY plane are observed.

A purpose of the parametric scan is to find an optimal combination of the length and width of the microwave resonant cavity to achieve optimal electric field uniformity and minimal microwave reflection loss. For example, the length and width of the microwave resonant cavity may be set as variables in the electromagnetic simulation software, and a scan range and a scan step may be defined. After each simulation, an electric field strength distribution diagram on the center XY plane of the resonant cavity is recorded, and the reflection situation of the microwave energy is evaluated.

In some embodiments, a length of a long side of the rectangular waveguide is set to 1 unit length a, a length of a short side of the rectangular waveguide is set to 1 unit length b, and half of a wavelength (λ/2) of a microwave at a certain frequency in the liquid medium is defined as one unit, denoted by a letter c; and scan parameters are as shown in Table 1:

TABLE 1
Parametric scan settings for the length, the width,
and the thickness of the microwave heating cavity

| Parameter | | |
|---|---|---|
| Name | Parameter Value List | Parameter Content |
| Horn_ux | Range (1.0a, 0.5a, 4.0a) | Microwave heating |
| | | cavity length |
| Horn_uy | Range (1.0b, 0.25b, 2.5b) | Microwave heating |
| | | cavity width |
| Horn_uz | Range (1.0c, 0.5c, 5.0c) | Microwave heating |
| | | cavity thickness |

Where, range (A, B, C) denotes performing a parametric scan from A to C with a scan step of B. For example, range (1.0a, 0.5a, 4.0a) denotes scanning from 1.0a to 4.0a with a scan step of 0.5a.

For example, for the 433 MHz microwave, a is 457.2 mm, b is 228.6 mm, c is 44.88 mm, and scan parameters are as shown in Table 2:

TABLE 2
Parametric scan settings for the length, the width,
and the thickness of 433 MHz microwave heating cavity

| Parameter | Parameter Value | Parameter Unit | |
|---|---|---|---|
| Name | List | (mm) | Parameter Content |
| Horn_ux | Range (1.0a, | Range (457.2, | Microwave heating |
| | 0.5a, 4.0a) | 228.6, 1828.8) | cavity length |
| Horn_uy | Range (1.0b, | Range (228.6, | Microwave heating |
| | 0.25b, 2.5b) | 57.15, 571.5) | cavity width |
| Horn_uz | Range (1.0c, | Range (44.88, | Microwave heating |
| | 0.5c, 5.0c) | 22.44, 224.40) | cavity thickness |

As another example, for the 915 MHz microwave (taking the specification BJ8 as an example), a is 292.1 mm, b is 146.05 mm, and c is 21.28 mm. The scan parameters are shown in Table 3 below.

TABLE 3
Parametric scan settings for the length, the width,
and the thickness of 915 MHz microwave heating cavity

| Parameter | Parameter Value | Parameter Unit | |
|---|---|---|---|
| Name | List | (mm) | Parameter Content |
| Horn_ux | Range (1.0a, | Range (292.1, | Microwave heating |
| | 0.5a, 4.0a) | 146.05, 1168.4) | cavity length |
| Horn_uy | Range (1.0b, | Range (146.05, | Microwave heating |
| | 0.25b, 2.5b) | 36.51, 365.13) | cavity width |
| Horn_uz | Range (1.0c, | Range (21.28, | Microwave heating |
| | 0.5c, 5.0c) | 10.64, 106.4) | cavity thickness |

In some embodiments of the present disclosure, by standardizing the rectangular waveguide size and the half-value of the medium wavelength as units a, b, and c, and performing a parametric scan on the length, width, and thickness of the microwave resonant cavity, the electric field distribution uniformity and the microwave reflection situation under different geometric size combinations are evaluated. This may accurately screen out the optimal cavity size, thereby significantly improving the electric field uniformity of the single-mode liquid microwave resonant cavity, reducing energy loss, and providing strong data support for subsequent optimization design.

To reduce the application cost of microwave technology, in addition to being applicable to microwave sources with adjustable phase, the following supplements the technical solution for controlling phase using a mechanical rectangular waveguide.

In S9: A waveguide wavelength λg at the microwave frequency ƒ is determined based on formula (3). A rectangular waveguide with height λg/2 is added to one side of the microwave resonant cavity. The microwave in the microwave resonant cavity changes by half a phase cycle (2*π).

The waveguide wavelength λg refers to the wavelength of the microwave at the microwave frequency ƒ when transmitted in a specific waveguide structure. The rectangular waveguide with height λg/2 acts as a phase corrector, which may cause the microwave passing through the rectangular waveguide to generate an additional 180-degree phase shift in the microwave resonant cavity.

In some embodiments, the formula (3) is as follows.

$${λ}_{{gTE}_{10}} = \frac{λ}{\sqrt{1 - {( \frac{λ}{2 a} )}^{2}}} \qquad ( 3 )$$

where λ is the wavelength of the microwave in the liquid medium; a is 1 unit length set as the length of the long side of the rectangular waveguide, λ_{gTE}_{₁₀} is a waveguide wavelength of a microwave type TE₁₀ wave. In some embodiments, since a cut-off frequency of the TE₁₀ wave is the lowest and it is suitable for single-mode transmission, the microwave resonator may adopt the TE₁₀ wave.

For example, according to the formula (3), a waveguide wavelength at the 433 MHZ frequency is calculated to be 1065.1 mm, and a corresponding height of the rectangular waveguide is 532.55 mm.

As another example, according to the formula (3), a waveguide wavelength at the 915 MHz frequency is calculated to be 303.36 mm. A rectangular waveguide with a height of λg/2=151.68 mm is added to one side of the resonant cavity. The microwave in the resonant cavity may change by half a phase cycle (2*π).

In S10: A tapered waveguide is introduced based on the simple model.

The tapered waveguide is a waveguide structure whose cross-sectional size gradually changes along the transmission direction.

A purpose of introducing the tapered waveguide is to better couple microwave energy from the rectangular waveguide to the microwave resonant cavity, expand the microwave coverage range, and simultaneously reduce reflection loss. For example, based on the simple model established in S6, the geometric structure of the tapered waveguide is added at the connection between the rectangular waveguide and the microwave resonant cavity using electromagnetic simulation software.

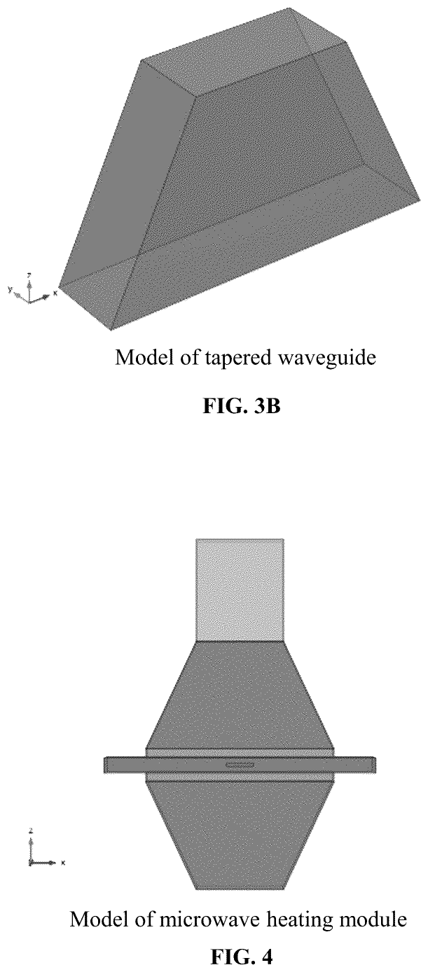

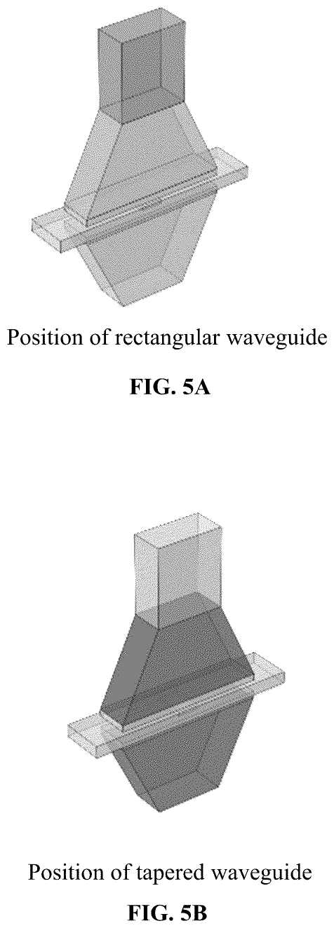

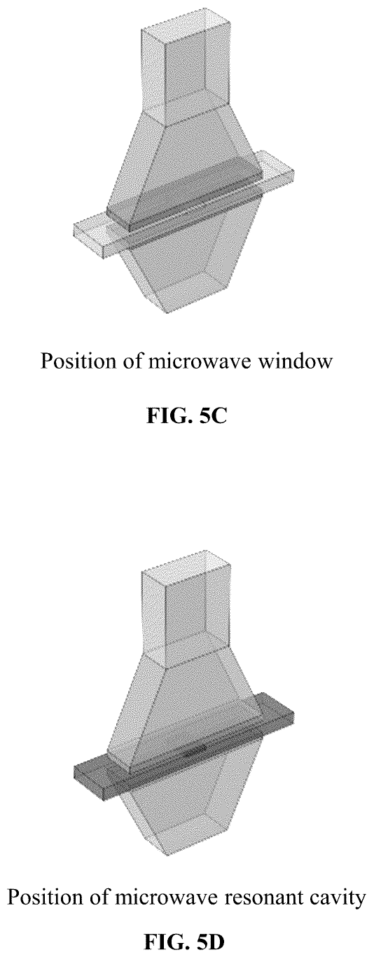

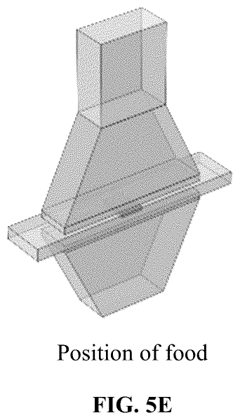

FIGS. 3A-3B are schematic diagrams illustrating an exemplary physical diagram and a numerical simulation geometric model of a tapered waveguide according to some embodiments of the present disclosure, where FIG. 3A is a physical tapered waveguide, and FIG. 3B is a numerical simulation geometric model of the tapered waveguide. FIG. 4 is a schematic diagram illustrating an exemplary numerical simulation geometric model of a microwave heating module according to some embodiments of the present disclosure. FIGS. 5A-5E are schematic diagrams illustrating exemplary compositions of a microwave heating module including a tapered waveguide according to some embodiments of the present disclosure, where FIG. 5A is a position of a rectangular waveguide, FIG. 5B is a position of a tapered waveguide, FIG. 5C is a position of a microwave window, FIG. 5D is a position of a microwave resonant cavity, and FIG. 5E is a position of a food.

The schematic diagram of the tapered waveguide is shown in FIG. 3. FIG. 3A is a processed physical diagram of the tapered waveguide. FIG. 3B is the numerical simulation geometric model of the tapered waveguide. In some embodiments, an upper and lower symmetric microwave resonant cavity may be established based on the numerical simulation model shown in FIG. 4. FIG. 5 shows positions of a rectangular waveguide, a tapered waveguide, a microwave window, a microwave heating cavity, and a food in a numerical simulation geometric model design.

In some embodiments, in S10, a geometric model of the microwave heating module is established using a finite element or finite-difference time-domain principle. A microwave field is added as a physical field based on Maxwell's equations. A study type is set to the frequency domain. A length of the rectangular waveguide is defined as a. A width of the rectangular waveguide is defined as b.

For example, related software based on the finite element or finite-difference time-domain principle is used to establish the numerical simulation model of the microwave heating module, as shown in FIG. 4. For example, simulation software includes COMSOL Multiphysics or CST Studio Suite.

The rectangular waveguide refers to a related rectangular waveguide specified by national standards for 433 MHz and 915 MHz.

In some embodiments of the present disclosure, by introducing a tapered waveguide, constructing a geometric model in combination with a finite element/finite-difference time-domain principle, performing frequency domain simulation based on Maxwell's equations, and standardizing a size of the rectangular waveguide, smooth coupling of microwave energy and uniform distribution within the liquid microwave resonant cavity are accurately achieved. Problems of low energy coupling efficiency and poor electric field uniformity in existing technologies are effectively solved. A solid technical foundation is provided for achieving efficient and stable microwave heating.

In S11: A parametric scan on a microwave window length, a microwave window width, and a tapered waveguide height is performed to complete an electric field cavity design.

For example, in the electromagnetic simulation software, the microwave window length, the microwave window width, and the tapered waveguide height are set as variable parameters. A plurality of simulation cases are run by performing a systematic parametric scan on these parameters. After each simulation, the uniformity of an electric field distribution within the resonant cavity, the reflection coefficient of microwave energy, and the transmission efficiency are evaluated.

For example, a range of the microwave window length is 1.0a to 2.5a, and a range of the microwave window width is 0.5b to 1.5b.

In some embodiments, in S11, the length of the long side of the rectangular waveguide is set to 1 unit length a, and the length of the short side of the rectangular waveguide is set to 1 unit length b. S11 includes:

In S111: First, the microwave window width is set to 1.0b, and a parametric scan on the microwave window length is performed. A parameter is defined as range (1.0a, 0.5a, 2.5a) and 1.75a, 2.15a, 2.25a, 2.35a. An optimal microwave window length and a plurality of alternative relatively optimal microwave window lengths may be determined based on the electric field distribution and practical application requirements.

In S112: The microwave window length is fixed, and a parametric scan on the microwave window width is performed. A parameter is set as range (0.5b, 0.1b, 1.5b). The microwave window width is determined based on actual sample production requirements and energy utilization.

In S113: After the microwave window length and the microwave window width are determined, a parametric scan on the tapered waveguide height is performed. A parameter scan range and a step are range (0.25a, 0.25a, 2a). The tapered waveguide height is selected based on the electric field distribution and the reflection situation.

In some embodiments of the present disclosure, a multi-stage, refined parametric scan method systematically optimizes the microwave window length, the microwave window width, and the tapered waveguide height. This step-by-step optimization strategy may accurately identify key geometric parameters affecting electric field uniformity and energy coupling. It significantly improves uniformity of the electric field distribution within the single-mode liquid microwave resonant cavity, while reducing microwave reflection loss. Thus, microwave heating efficiency and equipment performance are effectively improved.

In some embodiments, the method further includes S12: an influence of a change in the microwave frequency ƒ on the electric field distribution is determined to determine whether to use a single-frequency microwave or a band-frequency microwave. An influence of a frequency fluctuation within the ƒ frequency band on the electric field distribution is determined, a determination basis is the electric field distribution and the reflection situation on the XY plane at Z=0. A size of the microwave resonant cavity is set to an optimal microwave resonant cavity x*y*z, a microwave window size is set to wx*wy, a horn height is set to hh, a frequency scan scheme is set to range (ƒ−20, 5, ƒ+20) in MHz.

The single-frequency microwave refers to a microwave source operating at a single, fixed frequency. The band-frequency microwave refers to a microwave source that changes continuously or discontinuously within a certain frequency range. For example, if electric field uniformity is found to be optimal at a single frequency or within a narrow frequency band, the use of the single-frequency microwave may be determined. If good uniformity may be maintained over a relatively wide frequency range, or a more stable average effect may be achieved through frequency scanning, the use of the band-frequency microwave may be determined.

In some embodiments, an optimal microwave resonant cavity length, an optimal microwave resonant cavity width, and an optimal microwave resonant cavity thickness obtained from S4 and S8, and an optimal tapered waveguide height obtained from S11 may be used for frequency scanning. The frequency scan scheme is defined as range (ƒ−20, 5, ƒ+20).

For example, to investigate the influence of frequency fluctuation within the ƒ frequency band range on the electric field distribution, first, set the size of the microwave resonant cavity to the optimal microwave resonant cavity xyz determined through S8. The microwave window size is set to wx*wy determined through S11. A horn height (i.e., the tapered waveguide height) is set to hh determined through S11. Then, the frequency scan scheme is set to range (ƒ−20, 5, ƒ+20) in units of MHz. For example, if ƒ is 433 MHZ, the scan scheme is defined as range (413 MHz, 5 MHz, 443 MHZ). Z=0 typically represents a central plane of the liquid medium, which is a key region for evaluating heating uniformity. By analyzing an electric field strength distribution map (e.g., uniformity, peak-to-average ratio) and the reflection coefficient on this plane, the influence of frequency fluctuation on system performance may be evaluated.

In some embodiments of the present disclosure, by investigating the influence of microwave frequency variation and frequency fluctuation within the ƒ±20 MHz frequency band on the electric field distribution, and performing simulation analysis based on optimal cavity and coupling structure sizes, system robustness to frequency changes is effectively evaluated. Thus, whether to use the single-frequency microwave or the band-frequency microwave may be scientifically determined. This significantly improves operational stability and electric field uniformity of the single-mode liquid microwave resonant cavity, avoiding heating non-uniformity and energy loss caused by frequency deviation. It provides key technical support for reliable operation and efficient utilization of microwave equipment.

In some embodiments of the present disclosure, by performing comprehensive parametric scans and numerical simulations on a plurality of key physical parameters affecting the electric field distribution (including temperature-dependent dielectric constant of the medium, cavity geometric size, feed source phase, etc.), an influence law of each parameter on electric field uniformity and reflection loss may be scientifically and accurately revealed. An optimal design parameter combination may be found from a large number of possibilities. Thus, a microwave resonant cavity with a highly uniform electric field distribution and high energy efficiency is designed. The quality and consistency of microwave heating treatment for liquid materials are significantly improved. A design and development cycle for high-end microwave equipment is effectively shortened.

For the liquid single-mode resonant cavity, high-accuracy dielectric characteristic measurement is performed. Specific operations for designing the liquid single-mode resonant cavity are specified. Visualization of the electric field distribution is achieved. An optimal cavity design for the liquid single-mode resonant cavity is achieved. An optimal resonant cavity size and its limitations for equipment using microwave energy as an energy source at a certain frequency are effectively determined. Uniformity of the spatial distribution of the microwave electric field within the microwave liquid single-mode resonant cavity is effectively improved. Technical support is provided for subsequent utilization of microwave energy and development of microwave equipment.

It should be noted that the foregoing description of a process for the uniform electric field cavity design method for the single-mode liquid microwave resonant cavity is merely for illustration and description, and does not limit the applicable scope of the present disclosure. For those skilled in the art, various modifications and changes may be made to the foregoing process under the guidance of the present disclosure. However, these modifications and changes still fall within the scope of the present disclosure.

In some embodiments, the method is executed by a processor. Operations S7-S8 and S11 include: performing a parametric scan on a simple model based on simulation parameters. For more content regarding the simple model and the parametric scan, please refer to the related descriptions above.

The simulation parameters refer to data configuring and constraining the parametric scan. For example, the simulation parameters include a start value, an end value, and a scan step of a phase of an upper microwave source, a phase of a lower microwave source, a length of the microwave resonant cavity, a width of the microwave resonant cavity, the microwave window length, the microwave window width, and the tapered waveguide height. The start value refers to a minimum boundary value of a simulation parameter. The end value refers to a maximum boundary value of the simulation parameter. The scan step refers to a change value of the simulation parameter during each scan.

For more content regarding the parametric scan, please refer to operation S7 and related descriptions thereof.

Model parameters of the simple model include the phase of the upper microwave source, the phase of the lower microwave source, the length of the microwave resonant cavity, the width of the microwave resonant cavity, the microwave window length, the microwave window width, and the tapered waveguide height. The simulation parameters correspond one-to-one with the model parameters of the simple model.

In some embodiments, the processor may perform a plurality of rounds of iterations to perform the parametric scan on the simple model based on the simulation parameters. At least one round of iteration includes: reading a simulation parameter corresponding to at least one model parameter (e.g., a cavity length); using a start value of the simulation parameter as a set value for a first scan; using a sum of the scan step and the set value of the current scan as a set value for a next scan, to complete iterative updating of the set value for the scan. The parametric scan is completed when a preset condition is satisfied. The preset condition may include the set value for the scan reaching or exceeding the end value of the simulation parameter. In some embodiments, the processor may perform the parametric scan on a plurality of model parameters of the simple model in parallel or serially.

In some embodiments of the present disclosure, by performing the parametric scan, precise control over a simulation optimization process of the simple model is achieved. This not only avoids inefficiency and uncertainty of manual trial and error, but also provides a solid foundation framework for subsequent steps such as determining boundary values and scan step for the scan.

In some embodiments, the method further includes: generating at least one set of geometric parameters through a database based on a liquid type, a target temperature, and a dielectric constant and a dielectric loss corresponding to the target temperature; and generating simulation parameters based on the at least one set of geometric parameters.

The liquid type refers to a type of a liquid substance that is heated or processed in a microwave process. For example, the liquid type includes water, alcohols, oils, or the like.

The target temperature refers to a preset temperature that a liquid ultimately needs to reach in the microwave processing process. The liquid type and the target temperature may be obtained manually.

The geometric parameters refer to a set of numerical values that define physical dimensions and electromagnetic feed configurations of a microwave system. In some embodiments, the geometric parameters include phases of upper and lower microwave sources, a length and a width of a microwave resonant cavity, a microwave window length and a microwave window width, and a tapered waveguide height. Merely by way of example, the geometric parameters may be represented as: {phase: 1.05π, length of the microwave resonant cavity: 125 mm, width of the microwave resonant cavity: 86 mm, microwave window length: 70 mm, microwave window width: 20 mm, tapered waveguide height: 90 mm}.

In some embodiments, the processor constructs the liquid type, the target temperature, and the dielectric constant and the dielectric loss corresponding to the target temperature into a target vector, and determines the at least one set of geometric parameters by performing vector matching in a pre-established database based on the target vector.

The database includes a plurality of feature vectors and a plurality of corresponding labels. The feature vectors are constructed from the liquid type, the target temperature, and the dielectric constant, and the dielectric loss corresponding to the target temperature in a historical heating process. A label corresponding to the feature vector is a geometric parameter that enables a liquid to be uniformly heated to the target temperature in an actual historical heating process.

In some implementations, the processor may select K feature vectors with the highest similarity (e.g., cosine similarity) to the target vector in the database, and determine labels of geometric parameters corresponding to the K feature vectors as K sets of geometric parameters. A value of K may be preset based on experience.

In some embodiments, generating the at least one set of geometric parameters may also be implemented in other ways. For example, the geometric parameters that meet requirements of a specific liquid type and the target temperature may be directly calculated based on fluid dynamics and electromagnetic field theory in combination with numerical calculation manners.

In some embodiments, after receiving the at least one set of geometric parameters, for each model parameter that requires parametric scan, the processor may extract K corresponding numerical values from the K sets of geometric parameters; analyze the K numerical values, and select a minimum value and a maximum value of the K numerical values; use the minimum value and the maximum value as a start value and an end value of the model variable in the parametric scan, respectively; and determine a scan step size based on a difference between the start value and the end value. The processor sequentially performs the above process for all model parameters that require scanning, and finally generates a start value, an end value, and a corresponding scan step size for each model parameter.

The model parameters may include a length and a width of the microwave resonant cavity, a length and a width of the microwave window, a phase of the upper and lower microwave sources, and the tapered waveguide height. Merely by way of example, when K=5, extracted length values of the microwave resonant cavity may be {122 mm, 124 mm, 122 mm, 128 mm, 112 mm}, respectively. A smaller difference results in a smaller scan step, ensuring a reasonable initial sampling density in any scan range. For example, the scan step may be set to 50% of the difference between the start value and the end value.

In some embodiments, generating the simulation parameters may also be implemented in other ways. For example, an optimal scan range and step of the simulation parameters may be predicted by using a machine learning model based on historical simulation data, to improve simulation efficiency and accuracy.

In some embodiments of the present disclosure, by pre-determining an optimized scan range through the database, blind searches in a large amount of invalid parameter space are avoided, time and computational resources required for simulation calculations are reduced, thereby accelerating an entire cavity design process, reducing dependence on designer experience, and improving the success rate and repeatability of a design solution.

In some embodiments, the method further includes: identifying at least one sensitive interval of at least one model parameter based on the at least one set of geometric parameters; and adjusting a scan step based on the sensitive interval.

The sensitive interval refers to a range where parameter values are highly concentrated.

In some embodiments, the processor may obtain the K sets of geometric parameters; calculate a quantity of each parameter in the K sets of geometric parameters in a plurality of intervals divided according to the scan step size; and when a quantity in a certain interval is greater than a preset quantity threshold, the interval is determined as the sensitive interval. Merely by way of example, if length values of the microwave resonant cavity in the K sets of geometric parameters are {122 mm, 124 mm, 122 mm, 128 mm, 112 mm}, respectively, intervals divided according to a 50% scan step size (i.e., divided into two equal intervals) are mm, 120 mm) and [120 mm, 128 mm]. A quantity in the [112 mm, 120 mm) interval is 1, and a quantity in the [120 mm, 128 mm] interval is 4. If the preset quantity threshold is less than or equal to 4, [120 mm, 128 mm] is determined as the sensitive interval. At this time, the scan step size in this interval may be reduced. For example, simulation is performed in this interval according to a 50% scan step size (i.e., further dividing this interval into two equal intervals).

In some embodiments, a data clustering algorithm (e.g., K-means clustering) may be used to group geometric parameter values, and a region with high clustering density is identified as the sensitive interval.

In some embodiments, the processor may automatically reduce the scan step in the sensitive interval to perform a more detailed search; and automatically increase the scan step in a non-sensitive interval to accelerate simulation speed. For example, for the sensitive interval [120 mm, 128 mm] of the length of the microwave resonant cavity described above, the processor may reduce the scan step size in the sensitive interval from the original 50% to 25% of the difference between the start value and the end value, or smaller, and in the non-sensitive interval mm, 120 mm), the scan step may be increased.

In some embodiments of the present disclosure, by introducing identification of the sensitive interval and adaptive adjustment of the scan step, the efficiency of a simulation optimization process is improved. A core parameter range that has the most critical impact on a design result is automatically identified, and most computational resources are targeted and invested into this range for fine search, while fast rough scanning is performed in other non-critical areas. Compared with traditional fixed-step scanning, this manner may reduce redundant simulation calculation times without sacrificing or even improving optimization accuracy, and enables an algorithm to converge to a global optimum or a better local optimum solution faster.

In some embodiments, the microwave resonant cavity is applied to a microwave single-mode device. The microwave single-mode device is configured with a weighing sensor. The weighing sensor is configured to obtain physical position information of a medium to be heated in the microwave resonant cavity. The processor is further configured to: generate the at least one set of geometric parameters through the database based on the liquid type, the physical position information, the target temperature, and the dielectric constant and the dielectric loss corresponding to the target temperature.

For more content about the microwave single-mode device, refer to the related descriptions above.

The weighing sensor refers to a device capable of sensing a weight of an object and converting it into an electrical signal. For example, four small weighing sensors may be installed below a food tray of the microwave single-mode device, deployed at four corners of the tray, respectively, to obtain weight distribution information of the medium to be heated.

The physical position information refers to an actual spatial position of the medium to be heated inside the microwave resonant cavity. For example, a center-of-gravity coordinate of the medium to be heated (e.g., food), where a coordinate origin may be a center point of a tray on which the medium to be heated is placed.

In some embodiments, the processor may obtain data of the four weighing sensors and coordinate positions of the four sensors, respectively; and determine a center-of-gravity coordinate of the placement of the medium to be heated through a center-of-gravity calculation formula. An exemplary calculation process is: a coordinate of each sensor is (xi, yi), a reading is Wi, then an abscissa of the center-of-gravity coordinate is Xc=(Σ(Wi*xi))/(ΣWi), and an ordinate of the center-of-gravity coordinate is Yc=(Σ(Wi*yi))/(Σwi). Where Σ denotes summation over all sensors, and ΣWi denotes a total weight of the medium to be heated.

In some embodiments, the processor may also use a visual recognition system combined with image processing technology to estimate the physical position information by analyzing a contour and a shape of the medium to be heated.

In some embodiments, the processor may also generate the at least one set of geometric parameters through the database based on a liquid type of a current liquid, the physical position information, the target temperature, and the dielectric constant and the dielectric loss corresponding to the target temperature. For more content about the database, please refer to the related descriptions above. In this embodiment, the feature vector and the target vector of the database further include the physical location information.

In some embodiments of the present disclosure, by integrating a weight sensor array into a device and utilizing a center-of-gravity calculation formula, real-time and precise perception of the physical location information of the medium to be heated within the microwave heating cavity is achieved. This ensures that the input for simulation optimization is no longer a fixed, idealized center position, but rather real location data that includes random deviations encountered in actual operation. This may effectively compensate for potential heating unevenness and efficiency reduction caused by eccentric placement of items, thereby significantly improving the robustness of the heating system, the heating uniformity in practical applications, and the adaptability to different operational scenarios.

In some embodiments, performing the parametric scan on the microwave window length and the microwave window width and the tapered waveguide height in operation S11 includes: performing a parametric scan on the length and the width of the microwave window to determine a plurality of candidate parameter combinations for the microwave window length and the microwave window width; determining a preferred combination from the plurality of candidate parameter combinations through online physical verification based on the plurality of candidate parameter combinations; and based on the preferred combination, performing a parametric scan on the tapered waveguide height.

A candidate parameter combination refers to a parameter combination of a candidate length of the microwave window and a corresponding width of the microwave window.

The processor may obtain a result of the parametric scan and determine a parameter combination that satisfies a preset candidate condition as the candidate parameter combination based on a plurality of lengths and widths of the microwave window.

The preset candidate condition may be determined by a manual preset. Determining whether the preset candidate condition is satisfied may include: obtaining and scoring at least one of an electric field distribution during a simulation process, actual sample production requirements, and energy utilization for the parameter combination; and in response to a total score being greater than a score threshold, determining that the parameter combination meets the preset candidate condition. The score threshold may be determined based on a manual preset.

Online physical verification refers to an experimental testing and decision-making process performed on a physical device. In some embodiments, the online physical verification includes: based on each candidate parameter combination of the plurality of candidate parameter combinations sent by the processor, a controller of a microwave single-mode device sends a voltage signal to a drive mechanism coupled to a variable aperture to control the length and the width of the opening of the microwave window to be adjusted to the microwave window length and the microwave window width corresponding to the current candidate parameter combination. The physical device includes the microwave single-mode device, the drive mechanism, etc.

In some embodiments, the microwave single-mode device includes the controller.

The drive mechanism refers to an electromechanical system configured to perform dynamic adjustment of the microwave window. For example, the drive mechanism may be a micro stepper motor. In some embodiments, the drive mechanism may be coupled to the variable aperture. The variable aperture refers to an aperture used to change the size of the opening of the microwave window for adjusting the equivalent impedance of the microwave window.

The preferred combination refers to the parameter combination of the length of the microwave window and the width of the microwave window used when performing the parametric scan on the tapered waveguide. In some embodiments, the processor may perform the parametric scan on the tapered waveguide height based on the preferred combination.

In some embodiments, the processor may perform the online physical verification based on the plurality of candidate parameter combinations and determine a candidate parameter combination that satisfies a preferred condition from the plurality of candidate parameter combinations as the preferred combination. The processor may select a candidate parameter combination with the best performance as an optimal combination, i.e., the preferred combination, based on one or more of the electric field distribution during the physical verification process, actual sample production requirements, and energy utilization. For example, the processor may monitor a reflected power of each online physical verification through a directional coupler and a power meter installed in the rectangular waveguide. Since a lower reflected power indicates higher efficiency, the processor may determine a candidate parameter combination with a reflected power lower than a reflection threshold as the preferred combination. The reflection threshold may be determined based on empirical preset.

In some embodiments of the present disclosure, by introducing an online physical verification step into the design process and constructing a closed-loop design method of “simulation prediction-physical test-feedback decision,” the theoretical reliability of the finally determined parameters of the microwave window may be ensured, the performance effect of the optimized design method in the actual physical system may be optimized, and the practical performance, stability, and engineering utility value of the design method may be improved.

To further illustrate the uniform electric field cavity design method for the single-mode liquid microwave resonant cavity provided in the present disclosure, embodiments 2 to 9 and comparative examples 1 to 9 are provided below.

### Comparative Example 1

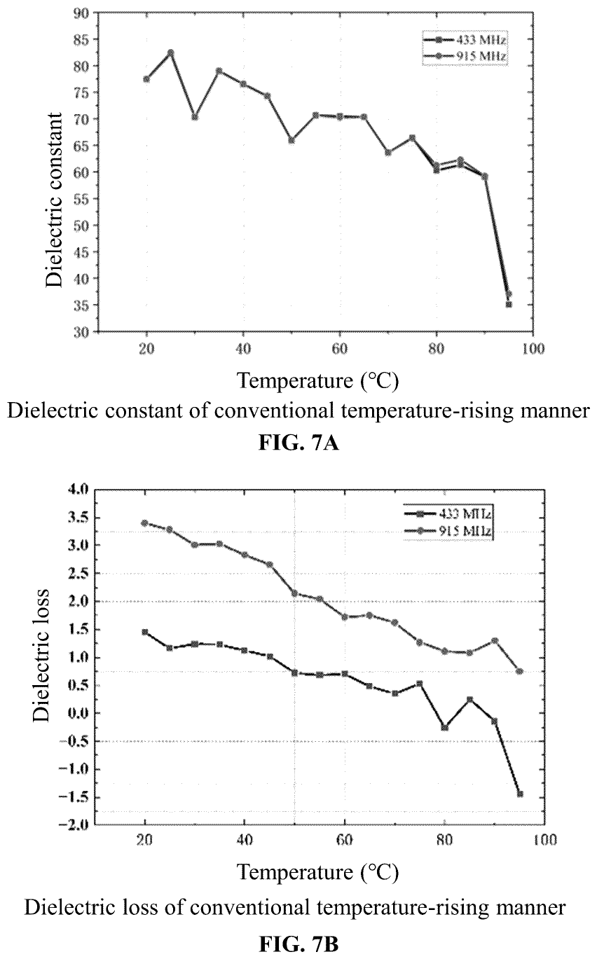

FIGS. 7A-7B are schematic diagrams illustrating exemplary dielectric properties of a water medium at 433 MHz and 915 MHz measured using a conventional temperature-rising manner according to some embodiments of the present disclosure, where FIG. 7A is a dielectric constant, and FIG. 7B is a dielectric loss.

In Comparative Example 1, the dielectric constant of water at 433 MHz was directly measured using a temperature-rising manner. The Comparative Example 1 adopted the same research operations as Embodiments 1, with a difference that the temperature-rising manner is used in S2, including:

In S2: the dielectric constants of the medium were collected at the 433 MHz frequency point, where the temperature included 90° C.

In S21: Specifically, 500 mL of purified water was measured using a beaker or other glass container. The container was covered with a sealing film to prevent water vapor loss due to temperature increase.

In S22: The container containing the purified water was placed in a heatable water bath. A temperature measurement device was placed in a middle and lower part of the purified water.

In S23: Calibration was performed using a vector network analyzer equipped with a dielectric property measurement probe. A calibrated instrument was obtained using air, a metal correction module, and 25° C. deionized water in sequence.

In S24: The temperature of the purified water was gradually increased to 95° C. A plurality of real-time temperature changes were recorded. The dielectric constants and the dielectric losses of the purified water in ranges of 413 MHz to 443 MHz and 895 MHz to 925 MHz were collected using the vector network analyzer and the dielectric property measurement probe. The plurality of temperatures were matched with the dielectric constants and the dielectric losses corresponding to temperature-rising moments.

A result of measuring the dielectric properties at 433 MHz using the temperature-rising manner in Comparative Example 1 is shown in FIG. 7. As shown in FIG. 7A, the dielectric constant at 433 MHz and 915 MHz exhibits a zigzag pattern with temperature change. This is because, during the temperature-rising process, water vapor continuously adheres to the detection part of the probe, resulting in the measured dielectric constant being a mixed dielectric constant of water and the water vapor/oxygen in the bubbles. This dielectric constant deviates significantly from the actual value and will cause a large error when used to calculate the wavelength of microwaves in water. As shown in FIG. 7B, the dielectric loss of water gradually decreases with increasing temperature, and the dielectric loss at 433 MHz becomes less than 0 when the temperature reaches about 80° C., indicating that the parameters measured by the instrument have produced impossible distorted data. Therefore, it is difficult to accurately measure the variation of the dielectric properties of the liquid medium with temperature using the traditional temperature-rising manner.

### Embodiment 2

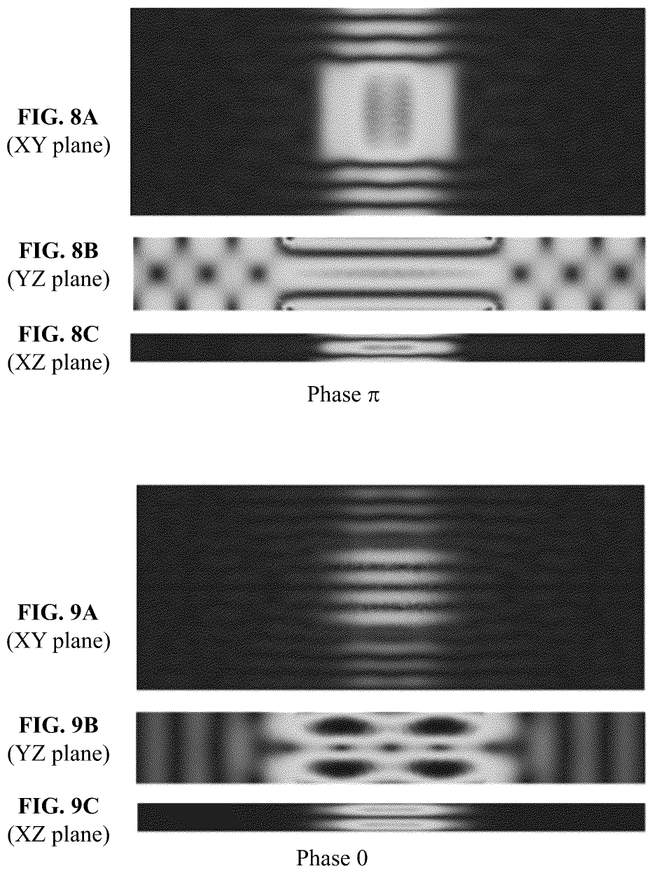

FIGS. 8A-8C are schematic diagrams illustrating an exemplary influence of a phase difference of x between an upper microwave source and a lower microwave source of a 433 MHz microwave on an electric field distribution (heating mode) according to some embodiments of the present disclosure, where FIG. 8A is an electric field distribution in an XY plane, FIG. 8B is an electric field distribution in a YZ plane, and FIG. 8C is an electric field distribution in an XZ plane.

In Embodiment 2, the influence of a phase difference of x between the upper microwave source and the lower microwave source on the electric field distribution when the 433 MHz microwave uses a BJ5 waveguide was measured.

In Embodiment 2, using the phase difference x as the phase difference between the upper phase and the lower phase of the microwave resonant cavity, the electric field distribution on the middle layer XY plane of the microwave resonant cavity as shown in FIG. 8 was obtained. For the 433 MHz microwave with a phase difference of π, it indicates that the XY plane is biased towards red, indicating that the electric field strength in the central region is higher. For the YZ plane, it indicates that there is a higher electric field distribution in the middle layer, followed by a certain electric field in the uppermost and lowermost parts. For the XZ plane, it indicates that the electric field is almost concentrated in the center of the X and Z directions of the microwave heating cavity, which is usually the location of the food.

### Comparative Example 2

FIG. 9A-9C are schematic diagrams illustrating an exemplary influence of a phase difference of 0 between an upper microwave source and a lower microwave source of a 433 MHz microwave on an electric field distribution (heating mode) according to some embodiments of the present disclosure, where FIG. 9A is an electric field distribution in an XY plane, FIG. 9B is an electric field distribution in a YZ plane, and FIG. 9C is an electric field distribution in an XZ plane. FIG. 10A-10C are schematic diagrams illustrating an exemplary influence of a phase difference of π/2 between an upper microwave source and a lower microwave source of a 433 MHz microwave on an electric field distribution (heating mode) according to some embodiments of the present disclosure, where FIG. 10A is an electric field distribution in an XY plane, FIG. 10B is an electric field distribution in a YZ plane, and FIG. 10C is an electric field distribution in an XZ plane.

In Comparative Example 2, the influence of a phase difference of 0 (or 2π) between the upper microwave source and the lower microwave source on the electric field distribution when the 433 MHz microwave uses a BJ5 waveguide was measured.

In Comparative Example 2, for S7, when the phase difference between the upper and lower microwave sources of the microwave heating cavity was selected as 2π or 0, the electric field distribution in the XY plane is shown in FIG. 9A. The electric field strength at the center of the XY plane is relatively small. Additionally, four relatively dispersed bands are presented, which may cause uneven heating of the food. The temperature is higher at the bands and lower in the middle of the bands.

In Comparative Example 2, the electric field distribution in the YZ plane when the phase difference is 2π or 0 is shown in FIG. 9B. The electric field is divided into four lobes around the center, forming a region where the electric field is almost zero in the central area. When the food is located here, an internal center of the food may not be heated. This does not conform to the principle of using a microwave resonant cavity for heating food.

In Comparative Example 2, the electric field distribution in the XZ plane when the phase difference is 2π or 0 is shown in FIG. 9. Here, the electric field is concentrated on the upper side and the lower side in the Z direction. The electric field distribution in the middle is biased towards blue, indicating that the electric field strength is almost zero.

FIG. 10 shows the electric field distribution when the phase difference between the upper and lower microwave sources is π/2. In Comparative Example 2, overall, the electric field distribution in the XY plane, the YZ plane, and the XZ plane is similar to that when the phase difference is π. As shown in the YZ plane in FIG. 10B, the microwave electric field on the upper side is smaller than that on the lower side. This indicates that for the food, the temperature of the upper part may be lower than that of the lower part. Heating the entire food will exacerbate the temperature non-uniformity phenomenon between the upper side and the lower side.

### Embodiment 3

FIG. 11A-11C are schematic diagrams illustrating an exemplary electric field distribution when a 433 MHz microwave uses a BJ5 waveguide and a thickness of a microwave resonant cavity is 80 mm (89.14% of a wavelength) according to some embodiments of the present disclosure, where FIG. 11A is an electric field distribution in an XY plane, FIG. 11B is an electric field distribution in a YZ plane, and FIG. 11C is an electric field distribution in an XZ plane.

In Embodiment 3, the influence of a resonant cavity thickness of 80% to 95% on the electric field distribution when a 433 MHz microwave uses a BJ5 waveguide was measured, including the following operations:

In S1: The microwave frequency ƒ was determined as 433 MHz.

In S2: The dielectric constants of the medium at the 433 MHz frequency point were collected. During the collecting, a medium temperature was raised to about 95° C. and the medium temperature was allowed to naturally decrease over time. A plurality of temperatures and the dielectric constants and dielectric losses at the plurality of temperatures were recorded.

In S3: The wavelength of the microwave in the purified water in the 433 MHz frequency band was determined as 89.75 mm according to the formula (2).

In S4: According to the formation principle of the single-mode cavity and the application scenario of the actual microwave resonant cavity, the thickness of the microwave resonant cavity was set as the limiting factor. The thickness of the microwave resonant cavity was determined as λ*(80%-95%), which is 71.80 mm-86.26 mm.

In S5: The specification of the rectangular waveguide was selected as BJ5 according to the microwave frequency and GB/T 11450.2-1989.

In S6: The simple model including only the rectangular waveguide, the microwave window, and the microwave resonant cavity was established.

In S7: The parametric scan on the phase of the upper microwave source and the lower microwave source of the simple model was performed, and the microwave electric field distribution in the microwave resonant cavity was analyzed. For most microwave application scenarios, the microwave electric field should be distributed in the geometric center region of the microwave single-mode device, thereby facilitating the placement or removal of food. Therefore, when performing phase influence result determination, the dispersion, concentration, and electric field strength of the microwave electric field should be primarily studied. The specific operations for determining the phase influence are the same as those in the Embodiments 1.

In S8: The parametric scan on the length and the width of the microwave resonant cavity was performed; the electric field distribution and the reflection situation in the XY plane were observed. The length of the long side of the rectangular waveguide was set as 1 unit length a, and the length of the short side of the rectangular waveguide was set as 1 unit length b, and half of the wavelength (λ/2) of the microwave in the liquid medium at a certain frequency was defined as one unit, denoted by the letter c. In Embodiment 3, a was 457.2 mm, b was 228.6 mm, and c was 44.88 mm. The scan parameters are the same as those in Embodiments 1.

In S9: The waveguide wavelength λg at 433 MHz was determined based on the formula (3). The rectangular waveguide with height λg/2 was added to one side of the resonant cavity. The microwave in the resonant cavity changed by half a phase cycle (2*π). In Embodiment 3, the waveguide wavelength obtained by calculation according to the formula (3) was 1065.1 mm, and the height of the rectangular waveguide was 532.55 mm.

$${λ}_{{gTE}_{10}} = \frac{λ}{\sqrt{1 - {( \frac{λ}{2 a} )}^{2}}} \qquad ( 3 )$$

S10: The tapered waveguide was introduced based on the simple model. A schematic diagram of the tapered waveguide is shown in FIG. 3, where FIG. 3A is a physical diagram of the tapered waveguide; FIG. 3B is a numerical simulation geometric model of the tapered waveguide. As shown in FIG. 4, an upper and lower symmetric microwave resonant cavity was established. FIG. 5 shows the positions of the rectangular waveguide, the tapered waveguide, the microwave window, the microwave heating cavity, and the food in the numerical simulation geometric model design.

In Embodiment 3, software based on the finite element or finite-difference time-domain principle may be used to establish the numerical simulation model of the microwave heating module, as shown in FIG. 4. The microwave field was added as a physical field based on Maxwell's equations, and the study type was set as frequency domain. Similarly, the length of the rectangular waveguide specified by the national standard was defined as a (457.2 mm), and the width of the rectangular waveguide is defined as b (228.6 mm). The main function of the microwave window is to allow the microwave emitted by the microwave source to pass through after entering the rectangular waveguide, thereby entering the microwave resonant cavity. The food is heated in the microwave resonant cavity. Therefore, the dimension of the microwave window affects the electric field distribution in the heating cavity.

S11: The parametric scan on the microwave window length of 1.0a-2.5a, the microwave window width of 0.5b-1.5b, and a tapered waveguide height of 0.25a-2a was performed. The length of the long side of the rectangular waveguide was set as 1 unit length a, and the length of the short side of the rectangular waveguide was set as 1 unit length b. In Embodiment 3, the microwave window length was 457.2 mm-1143 mm, the microwave window width was 114.3 mm-342.9 mm, and the tapered waveguide height was 114.3 mm-914.4 mm.

In Embodiment 3, S11 includes S111-S113:

In S111: First, the microwave window width was set to 1.0b, and a parametric scan on the microwave window length was performed. A parameter was defined as range (1.0a, 0.5a, 2.5a) and 1.75a, 2.15a, 2.25a, 2.35a. An optimal microwave window length and a plurality of alternative relatively optimal microwave window lengths may be determined based on the electric field distribution and practical application requirements.

In S112: The microwave window length was fixed, and a parametric scan on the microwave window width was performed. A parameter was set as range (0.5b, 0.1b, 1.5b). The microwave window width was determined based on actual sample production requirements and energy utilization.

In S113: After the microwave window length and the microwave window width were determined, a parametric scan on the tapered waveguide height was performed. A parameter scan range and a step were range (0.25a, 0.25a, 2a). The tapered waveguide height was selected based on the electric field distribution and the reflection situation.

In S12: The optimal microwave heating cavity length, optimal microwave heating cavity width, and optimal microwave heating cavity thickness, and the optimal tapered waveguide height obtained above were adopted. The frequency scan was performed and the frequency scan scheme was defined as range (413 MHz, 5 MHz, 443 MHZ).

In Embodiment 3, taking 433 MHz as an example, the thermal pattern diagram when the resonant cavity thickness of 80% to 95% is adopted is shown in FIG. 11. As shown in FIG. 11, when a thickness of the microwave resonant cavity is 90% of a wavelength at 433 MHz in water, an electric field distribution in an XY plane, a YZ plane, and an XZ plane is concentrated in the center of the microwave resonant cavity. In the YZ plane, no electric field concentration phenomenon is observed at a microwave window, and no sparking phenomenon caused by excessive electric field strength occurs.

### Comparative Example 3

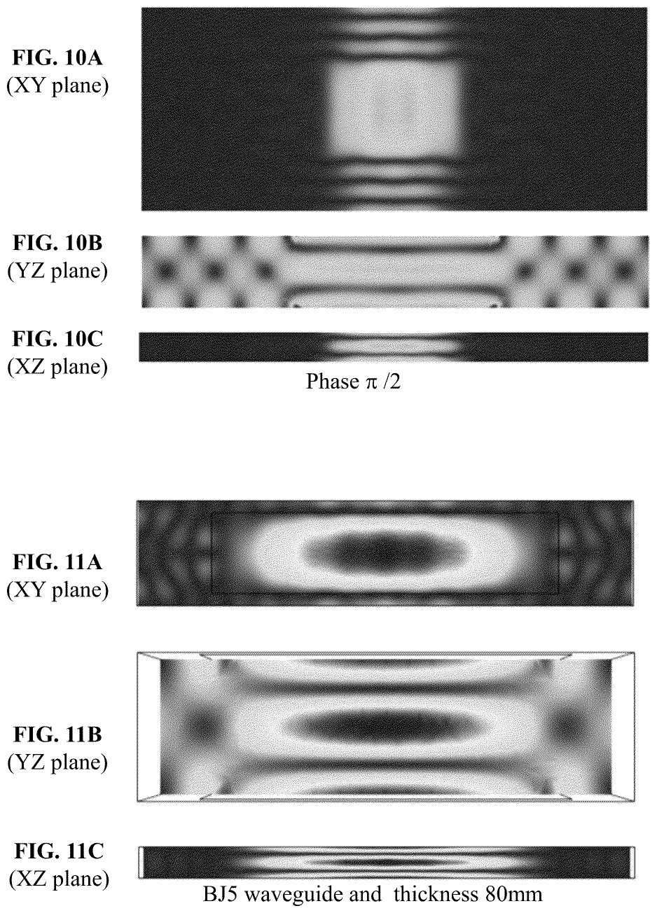

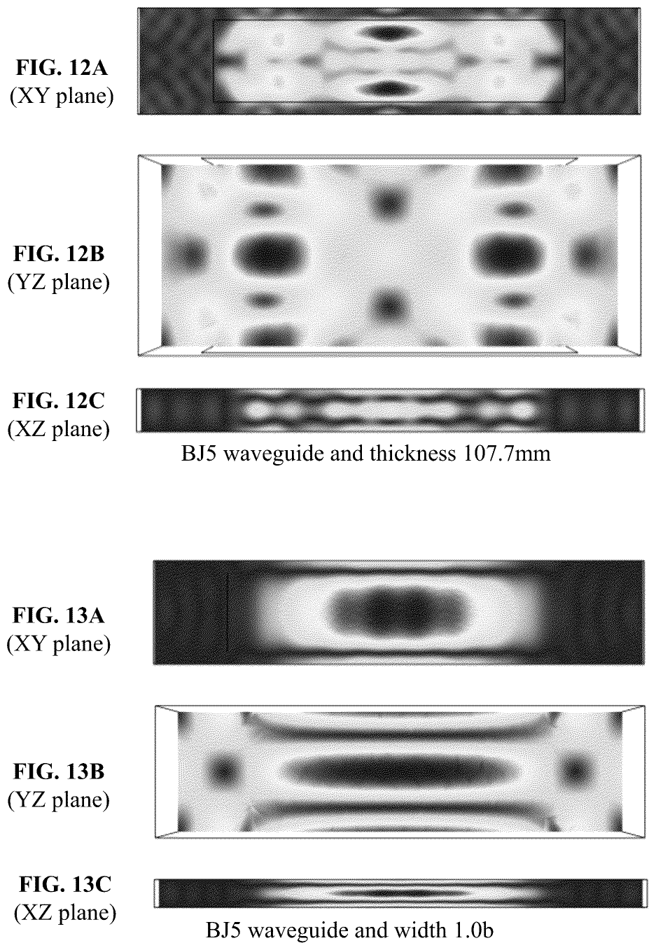

FIG. 12A-12C are schematic diagrams illustrating an exemplary electric field distribution when a 433 MHz microwave uses a BJ5 waveguide and a thickness of a microwave resonant cavity is 107.7 mm (120% of a wavelength) according to some embodiments of the present disclosure, where FIG. 12A is an electric field distribution in an XY plane, FIG. 12B is an electric field distribution in a YZ plane, and FIG. 12C is an electric field distribution in an XZ plane.

In Comparative Example 3, an influence of the thickness of the microwave resonant cavity not conforming to 80%-95% on the electric field distribution when the 433 MHZ microwave uses the BJ5 waveguide was measured.

In Comparative Example 3, when the thickness of the microwave resonant cavity was 1.2 times the wavelength, a size requirement of the single-mode microwave resonant cavity was no longer satisfied. As shown in FIG. 12A, an overall electric field distribution in the XY plane includes two high electric field strength regions with electric field concentration on upper and lower sides and four secondary high electric field strength regions distributed at corners. An overall relatively chaotic electric field distribution is presented. FIG. 12B shows the electric field distribution in the YZ direction. Similarly, there are six regions with relatively high electric field strength, distributed in a middle layer, an upper layer, and a lower layer. In this case, there are many cold spot distribution positions when the microwave is used to process food, and effective positioning may not be performed. Required uniform heating may not be achieved either.

### Embodiment 4

FIG. 13A-13C are schematic diagrams illustrating an exemplary electric field distribution when a 433 MHz microwave uses a BJ5 waveguide and a width of a microwave window is 1.0b according to some embodiments of the present disclosure, where FIG. 13A is an electric field distribution in an XY plane, FIG. 13B is an electric field distribution in a YZ plane, and FIG. 13C is an electric field distribution in an XZ plane.

In Embodiment 4, the electric field distribution was measured when the 433 MHZ microwave uses the BJ5 waveguide, the microwave window width conforms to 0.8b-1.1b, and is 1.0b.

In Embodiment 4, as shown in FIG. 13, the electric field distributions in the XY plane, the YZ plane, and the XZ plane show that when the microwave window is 1.0b, the middle layer where food is located may effectively achieve microwave heating, and the interior of the food achieves effective and rapid temperature rise. When a certain temperature difference exists between an external water medium and the food, external heating of the food may be effectively performed.

### Comparative Example 4

In Comparative Example 4, the electric field distribution was measured when the 433 MHz microwave uses the BJ5 waveguide, the microwave window width does not conform to 0.8b-1.1b, and is 0.5b and 1.2b.

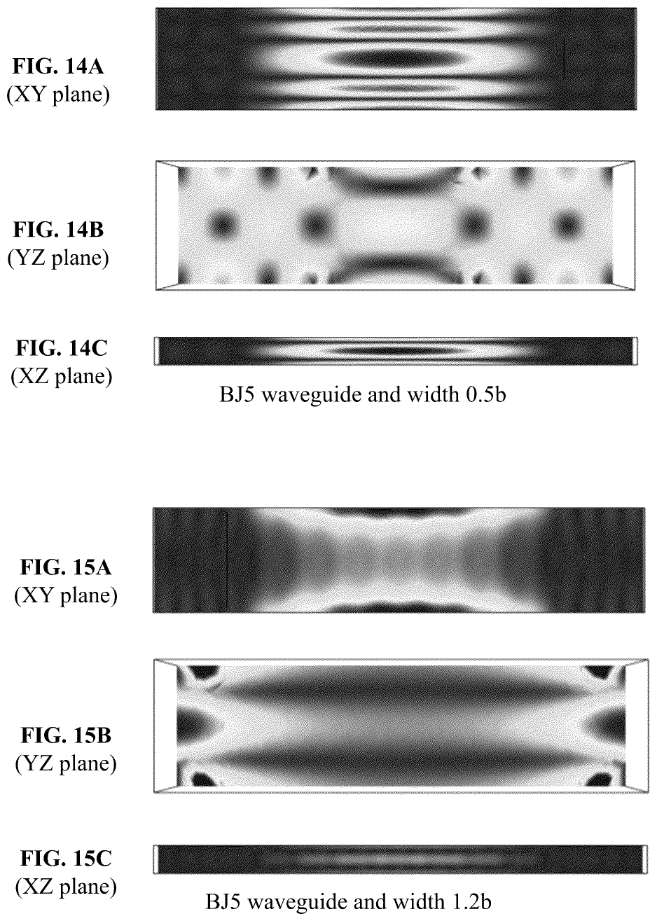

FIG. 14A-14C are schematic diagrams illustrating an exemplary electric field distribution when a 433 MHz microwave uses a BJ5 waveguide and a width of a microwave window is 0.5b according to some embodiments of the present disclosure, where FIG. 14A is an electric field distribution in an XY plane, FIG. 14B is an electric field distribution in a YZ plane, and FIG. 14C is an electric field distribution in an XZ plane.

In Comparative Example 4, when the microwave window width is 0.5b, as shown in FIG. 14A, a larger electric field region in the XY plane is divided into three ellipses and two semi-ellipses at upper and lower parts. As shown in FIG. 14B, the YZ plane has a secondary high electric field region in a central area, but an electric field concentration phenomenon occurs at the microwave window.

In comparative Example 4, when the microwave window width is 1.2b, as shown in FIG. 15A, in the XY plane, high electric field regions are at upper and lower sides, and the food at the center of the cavity may not be effectively heated at this time. As shown in FIG. 15B, in the YZ plane, a situation similar to that in the XY plane is presented. The microwave electric field is concentrated near two sides of the cavity and the microwave window, rather than in a middle region where the food should be located. Therefore, when the microwave window width is 0.5b and 1.2b, an effect of effectively heating the food may not be achieved.

### Embodiment 5

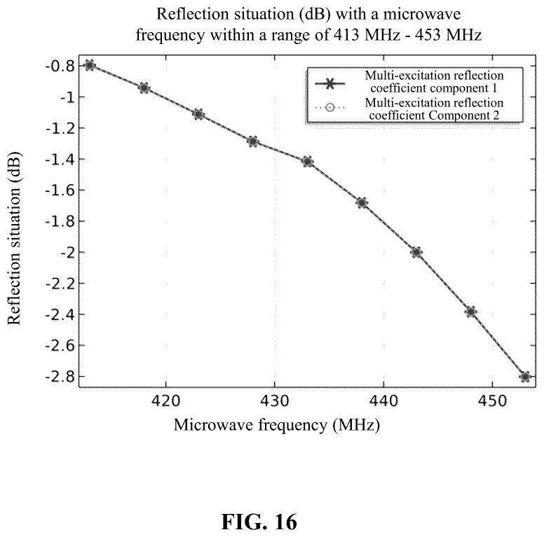

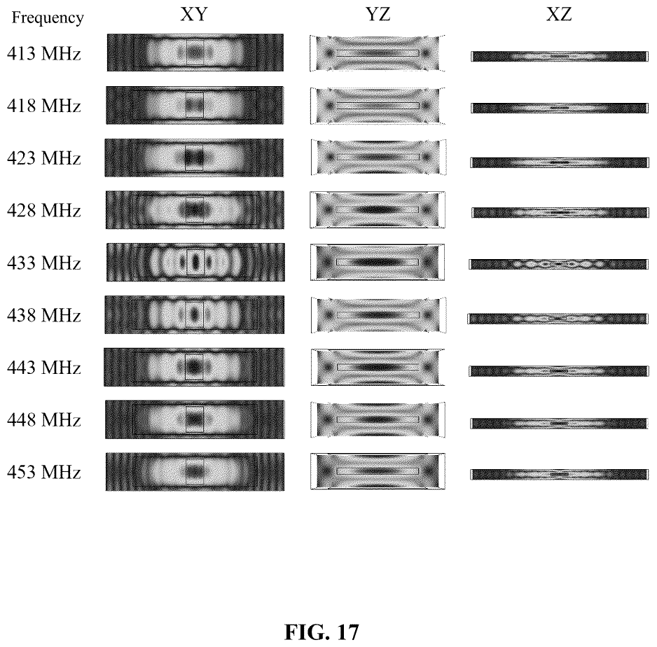

FIG. 16 is a schematic diagram illustrating an exemplary variation of a reflection situation with a microwave frequency within a range of 433 MHz±20 MHz according to some embodiments of the present disclosure, where a multi-excitation reflection coefficient component 1 is an upper microwave source, and a multi-excitation reflection coefficient component 2 is a lower microwave source. FIG. 17 is a schematic diagram of an exemplary influence of a microwave frequency, within a range of 433 MHZ±20 MHz, on an electric field distribution (heating mode) according to some embodiments of the present disclosure.

In Embodiment 5, the electric field distribution was measured when a single-frequency microwave of 433 MHz or a possible fluctuation frequency (±20 MHz) was used.

In Embodiment 5, S11 was used to study the reflection situation and the electric field distribution within a frequency band of 433 MHZ±15 MHz. As shown in FIG. 16, as the microwave frequency changes, the multi-excitation reflection coefficients of the upper and lower microwave sources gradually decrease. Therefore, for different frequencies, the electric field distribution is inevitably different.

In Embodiment 5, to more clearly display the electric field distribution, operation S13 was added. Food with the same material parameters was added to the microwave resonant cavity within the range of 433 MHz±15 MHz. The electric field distribution was observed. The results show that at 413 MHz, the electric field distribution in the food is relatively uniform, presenting a relatively regular circle. As the microwave frequency increases, the electric field distribution inside the food gradually splits at 418 MHz, and the electric field strength at left and right ellipses inside the food increases at 423 MHz. When the frequency is 428 MHz, the ellipses on both sides gradually converge and form a new small elliptical electric field at the center, which has the highest electric field distribution.

In Embodiment 5, when the frequency further increased to 448 MHz, the electric field further began to split. When the frequency reached 453 MHz, the electric field split into three overlapping ellipses.

Therefore, to maintain a relatively good and stable microwave heating mode, the selection of the microwave source needs to be as stable as possible. For example, selecting the single-frequency microwave as the microwave source may minimize changes in the microwave electric field.

### Embodiment 6

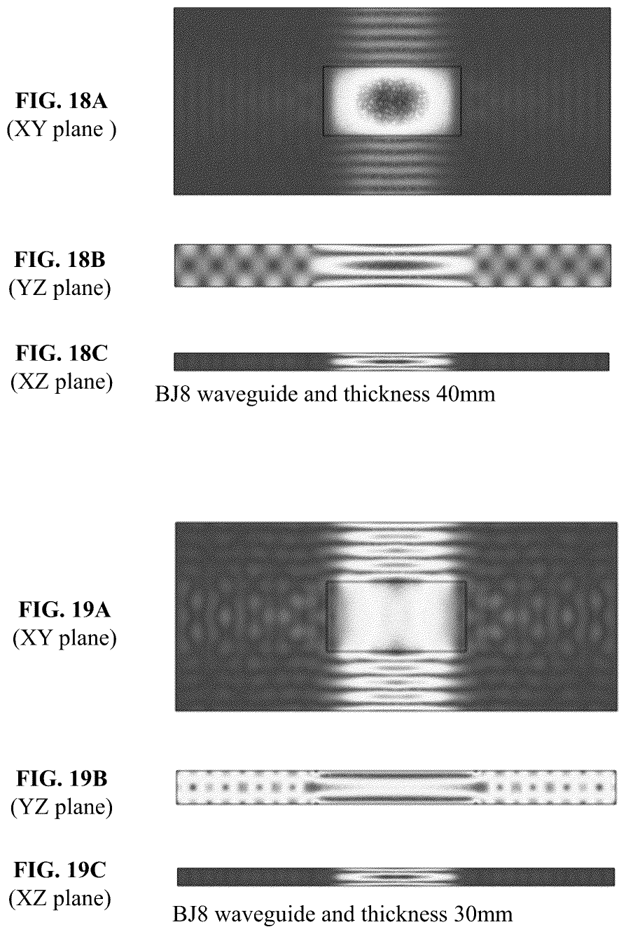

FIG. 18A-18C are schematic diagrams illustrating an exemplary electric field distribution when a 915 MHz microwave uses a BJ8 waveguide and a thickness of a microwave resonant cavity is 40 mm (94.11% of a wavelength) according to some embodiments of the present disclosure, where FIG. 18A is an electric field distribution in an XY plane, FIG. 18B is an electric field distribution in a YZ plane, and FIG. 18C is an electric field distribution in an XZ plane.

In Embodiment 6, the electric field distribution was measured when the 915 MHz microwave uses the BJ8 waveguide and the thickness of the microwave resonant cavity conforms to 80%-95% and is 94%, including the following operations:

In S1: The microwave frequency ƒ was determined as 915 MHz.

In S2: The dielectric constants of the medium at the 915 MHz frequency point were collected, and the temperature included 90° C. During the collecting, a medium temperature was raised to about 95° C. and the medium temperature was allowed to naturally decrease over time. A plurality of temperatures and the dielectric constants and dielectric losses at the plurality of temperatures were recorded.

In S3: The wavelength of the microwave in the purified water in the 915 MHz frequency band was determined as 89.75 mm according to the formula (2).

In S4: According to the formation principle of the single-mode cavity and the application scenario of the actual microwave resonant cavity, the thickness of the microwave resonant cavity was set as the limiting factor. The thickness of the microwave resonant cavity was determined as wavelength*(80%-95%), which was 34.08 mm-40.32 mm.

In S5: The specification of the rectangular waveguide was selected as BJ5 according to the microwave frequency and GB/T 11450.2-1989.

In S6: The simple model including only the rectangular waveguide, the microwave window, and the microwave resonant cavity was established.

In S7: The parametric scan on the phase of the upper microwave source and the lower microwave source of the simple model was performed, and the microwave electric field distribution in the microwave resonant cavity was analyzed. For most microwave application scenarios, the microwave electric field should be distributed in the geometric center region of the microwave single-mode device, thereby facilitating the placement or removal of food. Therefore, when performing phase influence result determination, the dispersion, concentration, and electric field strength of the microwave electric field should be primarily studied. The specific operations for determining the phase influence are the same as those in Embodiments 1.

In S8: The parametric scan on the length and the width of the microwave resonant cavity was performed; the electric field distribution and the reflection situation in the XY plane were observed. The length of the long side of the rectangular waveguide was set as 1 unit length a, and the length of the short side of the rectangular waveguide was set as 1 unit length b, and half of the wavelength (λ/2) of the microwave in the liquid medium at a certain frequency was defined as one unit, denoted by the letter c. In Embodiment 6, a was 292.1 mm, b was 146.05 mm, and c was 21.28 mm. The scan parameters are shown in Table 4 below:

TABLE 4
Parametric scan settings for the length, the width, and the
thickness of the microwave heating cavity in Embodiment 6

| Parameter | Parameter value | Parameter unit | |
|---|---|---|---|
| name | list | (mm) | Parameter content |
| Horn_ux | Range (1.0a, | Range (292.1, | Microwave heating |
| | 0.5a, 4.0a) | 146.05, 1168.4) | cavity length |
| Horn_uy | Range (1.0b, | Range (146.05, | Microwave heating |
| | 0.25b, 2.5b) | 36.51, 365.13) | cavity width |
| Horn_uy | Range (1.0c, | Range (21.28, | Microwave heating |
| | 0.5c, 5.0c) | 10.64, 106.4) | cavity thickness |

In Embodiment 6, as shown in FIG. 18, for 915 MHz, using a BJ8 rectangular waveguide, when the thickness of the resonant cavity is 40 mm, the electric field distribution in the XY plane is relatively uniform, and the region with a larger electric field is concentrated in the middle region. The electric field distribution in the YZ plane and the XZ plane shows that when the food is located in the middle position, the geometric center of the food is heated well.

### Comparative Example 6

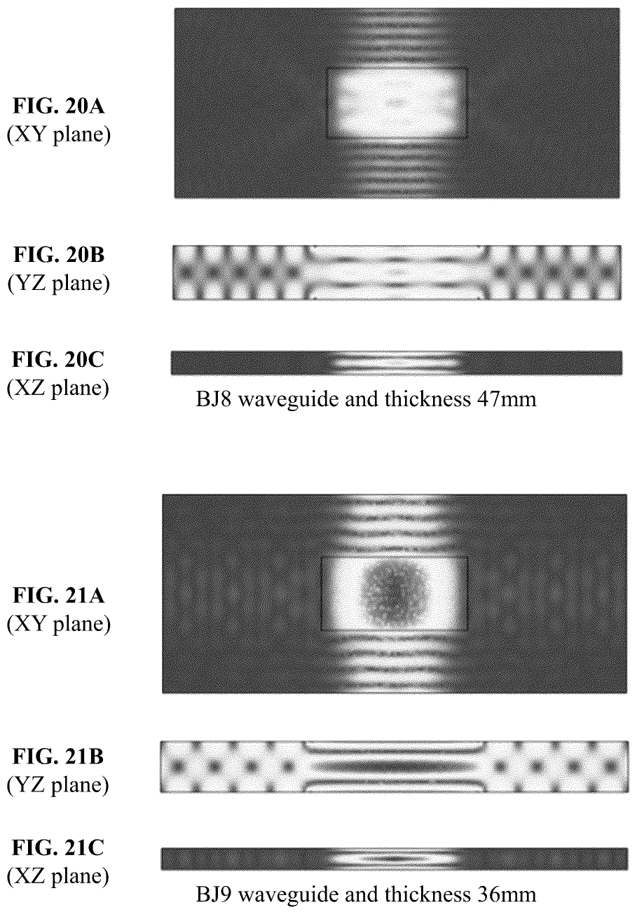

FIG. 19A-19C are schematic diagrams illustrating an exemplary electric field distribution when a 915 MHz microwave uses a BJ8 waveguide and a thickness of a microwave resonant cavity is 30 mm (71% of a wavelength) according to some embodiments of the present disclosure, where FIG. 19A is an electric field distribution in an XY plane, FIG. 19B is an electric field distribution in a YZ plane, and FIG. 19C is an electric field distribution in an XZ plane. FIG. 20A-20C are schematic diagrams illustrating an exemplary electric field distribution when a 915 MHz microwave uses a BJ8 waveguide and a thickness of a microwave resonant cavity is 47 mm (111% of a wavelength) according to some embodiments of the present disclosure, where FIG. 20A is an electric field distribution in an XY plane, FIG. 20B is an electric field distribution in a YZ plane, and FIG. 20C is an electric field distribution in an XZ plane.

In Comparative Example 6, the electric field distribution was measured when the microwave frequency was 915 MHz using a BJ8 waveguide and the thickness of the resonant cavity did not conform to 80% to 95%.

FIG. 19 shows the electric field distribution when the microwave frequency is 915 MHz using a BJ8 waveguide and the thickness of the resonant cavity is 30 mm (71%). In Comparative Example 6, the XY plane shows that the microwave electric field is concentrated on the upper side and the lower side of the microwave window. Furthermore, three long elliptical high electric field regions are presented above and below the microwave window.

FIG. 20 shows the electric field distribution when the microwave frequency is 915 MHz using a BJ8 waveguide and the thickness of the resonant cavity is 47 mm (111%). In Comparative Example 6, the XY plane shows that when the length of the resonant cavity is greater than 100%, the microwave in the microwave window region in the middle of the resonant cavity splits into two longer elliptical high electric field regions and one shorter elliptical high electric field region. At this time, when the resonant cavity is used for microwave heating, more microwave cold spots will appear, which is not conducive to the uniformity of microwave heating. The YZ plane further shows the discontinuity of the electric field in the YZ direction.

### Embodiment 7

FIG. 21A-21C are schematic diagrams illustrating an exemplary electric field distribution when a 915 MHz microwave uses a BJ9 waveguide and a thickness of a microwave resonant cavity 36 mm (84.59% of a wavelength) according to some embodiments of the present disclosure, where FIG. 21A is an electric field distribution in an XY plane, FIG. 21B is an electric field distribution in a YZ plane, and FIG. 21C is an electric field distribution in an XZ plane.

In Embodiment 7, the electric field distribution was measured when the microwave frequency was 915 MHz using a BJ9 waveguide and the thickness of the resonant cavity conformed to 80% to 95%, including the following operations.

In S1: The microwave frequency ƒ was determined as 915 MHz.

In S2: The dielectric constants of the medium at the 915 MHz frequency point were collected, and the temperature included 90° C. During the collecting, a medium temperature was raised to about 95° C. and the medium temperature was allowed to naturally decrease over time. A plurality of temperatures and the dielectric constants and dielectric losses at the plurality of temperatures were recorded.

In S3: The wavelength of the microwave in the purified water in the 915 MHz frequency band was determined as 42.56 mm according to the formula (2).

In S4: According to the formation principle of the single-mode cavity and the application scenario of the actual microwave resonant cavity, the thickness of the microwave resonant cavity was set as the limiting factor. The thickness of the microwave resonant cavity was determined as wavelength*(80%-95%), which is 34.05 mm to 40.43 mm.

In S5: The specification of the rectangular waveguide was selected as BJ9 according to the microwave frequency and GB/T 11450.2-1989.

In S6: The simple model including only the rectangular waveguide, the microwave window, and the microwave resonant cavity was established.

In S7: The parametric scan on the phases of the upper microwave source and the lower microwave source of the simple model was performed, and the microwave electric field distribution in the microwave resonant cavity was analyzed. For most microwave application scenarios, the microwave electric field should be distributed in the geometric center region of the microwave single-mode device, thereby facilitating the placement or removal of food. Therefore, when performing phase influence result determination, the dispersion, concentration, and electric field strength of the microwave electric field should be primarily studied. The specific operations for determining the phase influence are the same as those in Embodiments 1.

In S8: The parametric scan on the length and the width of the microwave resonant cavity was performed; the electric field distribution and the reflection situation in the XY plane were observed. The length of the long side of the rectangular waveguide was set as 1 unit length a, and the length of the short side of the rectangular waveguide was set as 1 unit length b, and half of the wavelength (λ/2) of the microwave in the liquid medium at a certain frequency was defined as one unit, denoted by the letter c. In Embodiment 7, a was 249.65 mm, b was 123.82 mm, and c was 21.28 mm. The scan parameters are shown in Table 5 below:

TABLE 5
Parametric scan settings for the length, the width, and the
thickness of the microwave heating cavity in embodiment 7

| Parameter | Parameter value | Parameter unit | |
|---|---|---|---|
| name | list | (mm) | Parameter content |
| Horn_ux | Range (1.0a, | Range (249.65, | Microwave heating |
| | 0.5a, 4.0a) | 124.83, 998.6) | cavity length |
| Horn_uy | Range (1.0b, | Range (123.82, | Microwave heating |
| | 0.25b, 2.5b) | 30.95, 309.55) | cavity width |
| Horn_uy | Range (1.0c, | Range (21.28, | Microwave heating |
| | 0.5c, 5.0c) | 10.64, 106.4) | cavity thickness |

FIG. 21 shows an electric field distribution when the 915 MHz microwave uses the BJ9 waveguide and the thickness of the resonant cavity is 36 mm (84.59% of a medium wavelength). In Example 7, high electric field concentration regions in the XY plane, the YZ plane, and the XZ plane are all located at the center of the resonant cavity, which is beneficial for heating food.

### Comparative Example 7

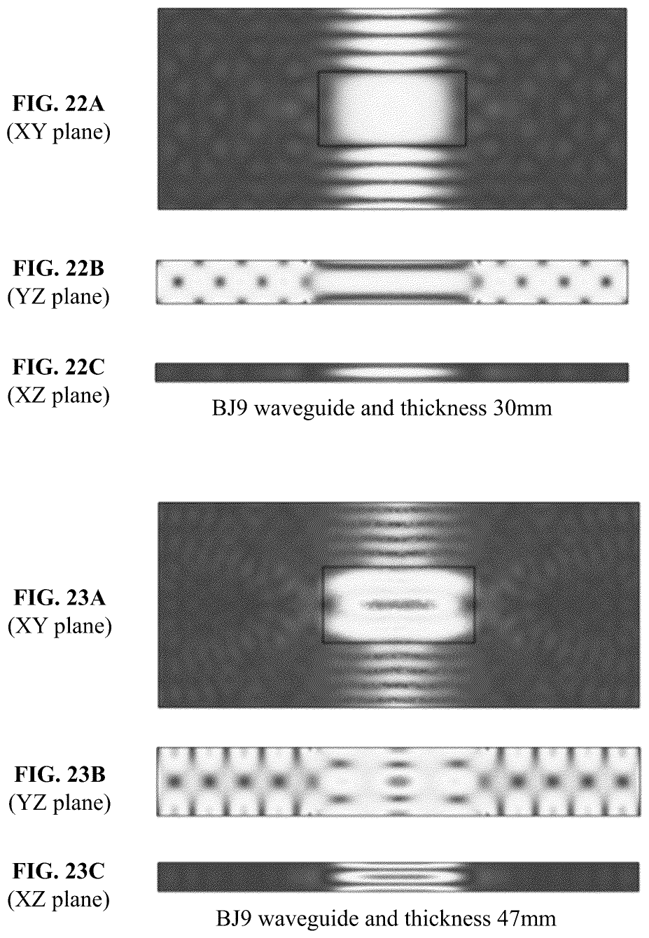

FIG. 22A-22C are schematic diagrams illustrating an exemplary electric field distribution when a 915 MHz microwave uses a BJ9 waveguide and a thickness of a microwave resonant cavity is 30 mm (71% of a wavelength) according to some embodiments of the present disclosure, where FIG. 22A is an electric field distribution in an XY plane, FIG. 22B is an electric field distribution in a YZ plane, and FIG. 22C is an electric field distribution in an XZ plane. FIG. 23A-23C are schematic diagrams illustrating an exemplary electric field distribution when a 915 MHz microwave uses a BJ9 waveguide and a thickness of a microwave resonant cavity is 47 mm (111% of a wavelength) according to some embodiments of the present disclosure, where FIG. 23A is an electric field distribution in an XY plane, FIG. 23B is an electric field distribution in a YZ plane, and FIG. 23C is an electric field distribution in an XZ plane.

In Comparative Example 7, the electric field distribution was measured when the 915 MHz microwave uses the BJ9 waveguide and the thickness of the resonant cavity does not meet 80%-95%.

FIG. 22 shows an electric field distribution when the 915 MHz microwave uses the BJ9 waveguide and the thickness of the resonant cavity is 30 mm (71% of a wavelength). In Comparative Example 7, the XY plane, the YZ plane, and the XZ plane have a higher electric field at the geometric center of the resonant cavity. However, there are three long oval electric fields on an upper side and a lower side of the XY plane microwave window, which have almost the same electric field strength as the center. The positions where these electric fields are located almost have no electric field passing through, which indicates that almost half of the microwave energy is absorbed by the medium in the cavity.

FIG. 23 shows an electric field distribution when the 915 MHz microwave uses the BJ9 waveguide and the thickness of the resonant cavity is 47 mm (111% of a wavelength). In Comparative Example 7, the electric field distribution pattern when using the BJ9 waveguide is different from that when using a BJ8 waveguide. This indicates that for different waveguides, the same numerical values may not be simply applied, and specific methods described in the present application need to be used for specific implementation. FIG. 23A shows an electric field distribution in the XY plane when the thickness of the resonant cavity is 47 mm, where an electric field region at the microwave window splits into one highest intensity electric field region at the center and two secondary high electric field regions above and below. The YZ plane further shows a result when the thickness of the resonant cavity exceeds 95%, where an electric field at the center is almost the same as about 10 circular secondary high electric field regions on the left and right sides. This indicates that the cavity may not be used for heating food.

### Example 8

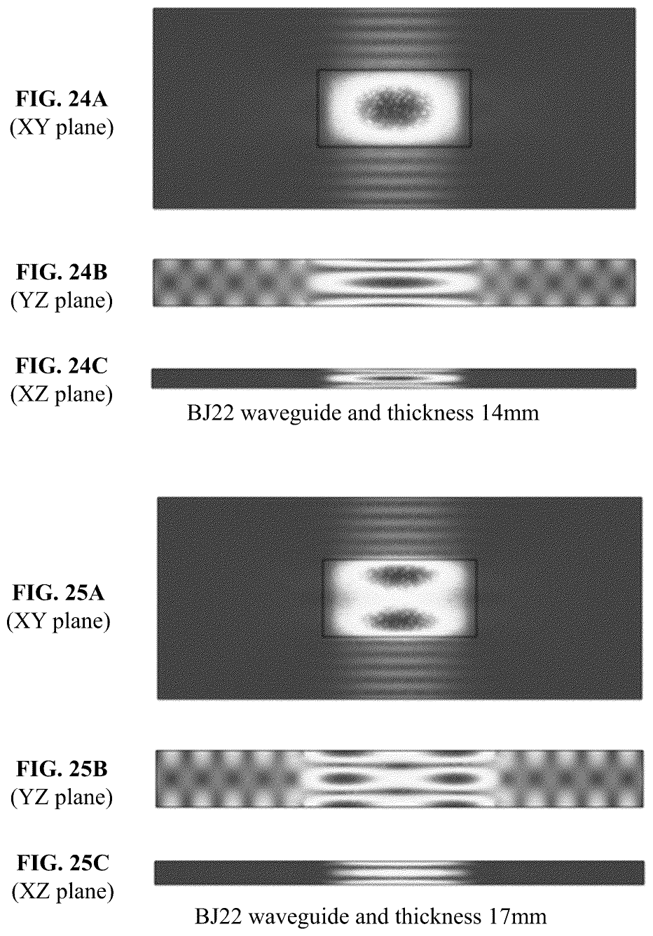

FIG. 24A-24C are schematic diagrams illustrating an exemplary influence of a thickness of a microwave resonant cavity (also referred to as the resonant cavity thickness) of 14 mm (88% of a wavelength) on an electric field distribution when a 2450 MHz microwave uses a BJ22 waveguide according to some embodiments of the present disclosure, where FIG. 24A is an electric field distribution in an XY plane, FIG. 24B is an electric field distribution in a YZ plane, and FIG. 24C is an electric field distribution in an XZ plane.

In Example 8, the electric field distribution was measured when the 2450 MHZ microwave uses the BJ22 waveguide and the thickness of a resonant cavity meets 80%-95%, including the following operations.

In S1: The microwave frequency ƒ was determined as 2450 MHZ.

In S2: The dielectric constants of the medium at the 2450 MHz frequency point were collected, and the temperature included 90° C. During the collecting, a medium temperature was raised to about 95° C. and the medium temperature was allowed to naturally decrease over time. A plurality of temperatures and the dielectric constants and dielectric losses at the plurality of temperatures were recorded.

In S3: The wavelength of the microwave in the purified water in the 2450 MHz frequency band was determined as 42.56 mm according to the formula (2).

In S4: According to the formation principle of the single-mode cavity and the application scenario of the actual microwave resonant cavity, the thickness of the microwave resonant cavity was set as the limiting factor. The thickness of the microwave resonant cavity was determined as wavelength*(80%-95%), which was 12.72 mm-15.11 mm.

In S5: The specification of the rectangular waveguide was selected as BJ22 according to the microwave frequency and GB/T 11450.2-1989.

In S6: The simple model including only the rectangular waveguide, the microwave window, and the microwave resonant cavity was established.

In S7: The parametric scan on the phase of the upper microwave source and the lower microwave source of the simple model was performed, and the microwave electric field distribution in the microwave resonant cavity was analyzed. For most microwave application scenarios, the microwave electric field should be distributed in the geometric center region of the microwave single-mode device, thereby facilitating the placement or removal of food. Therefore, when performing phase influence result determination, the dispersion, concentration, and electric field strength of the microwave electric field should be primarily studied. The specific operations for determining the phase influence are the same as those in the Embodiments 1.

In S8: The parametric scan on the length and the width of the microwave resonant cavity was performed; the electric field distribution and the reflection situation in the XY plane were observed. The length of the long side of the rectangular waveguide was set as 1 unit length a, and the length of the short side of the rectangular waveguide was set as 1 unit length b, and half of the wavelength (\/2) of the microwave in the liquid medium at a certain frequency was defined as one unit, denoted by the letter c. In Example 8, a was 109.22 mm, b was 54.61 mm, and c was 7.95 mm. The scan parameters are as shown in Table 6:

TABLE 6
Parametric scan settings for the length, the width, and
the thickness of microwave heating cavity in Example 8

| Parameter | Parameter value | Parameter unit | |
|---|---|---|---|
| name | list | (mm) | Parameter content |
| Horn_ux | Range (1.0a, | Range (109.22 | Microwave heating |
| | 0.5a, 4.0a) | 54.61, 436.88) | cavity length |
| Horn_uy | Range (1.0b, | Range (54.61, | Microwave heating |
| | 0.25b, 2.5b) | 13.65, 136.53) | cavity width |
| Horn_uy | Range (1.0c, | Range (7.95, | Microwave heating |
| | 0.5c, 5.0c) | 3.98, 39.75) | cavity thickness |

FIG. 24 shows an electric field distribution when a 2450 MHz microwave uses a BJ22 rectangular waveguide and a thickness of the resonant cavity is 14 mm. In Embodiment 8, high electric field regions in an XY plane, a YZ plane, and an XZ plane are located in the middle of the resonant cavity in X, Y, and Z directions. At this time, a high energy utilization rate is achieved when used for food heating.

### Comparative Example 8

FIG. 25A-25C are schematic diagrams illustrating an exemplary influence of a

thickness of a microwave resonant cavity of 17 mm (106% of a wavelength) on an electric field distribution when a 2450 MHz microwave uses a BJ22 waveguide according to some embodiments of the present disclosure, where FIG. 25A is an electric field distribution in an XY plane, FIG. 25B is an electric field distribution in a YZ plane, and FIG. 25C is an electric field distribution in an XZ plane.

In Comparative Example 8, the electric field distribution was measured when a 2450 MHz microwave uses a BJ22 waveguide and a thickness of the resonant cavity does not meet 80% to 95%.

FIG. 25 shows an electric field distribution when the 2450 MHz microwave uses the BJ22 waveguide and a thickness of the resonant cavity is 17 mm (106% of a medium wavelength). In Comparative Example 8, an electric field in the XY plane includes two elliptical high electric field regions. At this time, an electric field strength at a central position is small. When the food is present, upper and lower sides of the food are heated at this time, rather than a central region being heated. This cavity is not conducive to uniform heating of food. A heating efficiency of food at central, left, and right positions is low. The YZ plane also shows insufficient heating at a center of the food. The XZ plane shows that an electric field strength in a central region thereof is relatively similar to upper and lower sides, and is at an intermediate level of electric field strength.

### Embodiment 9

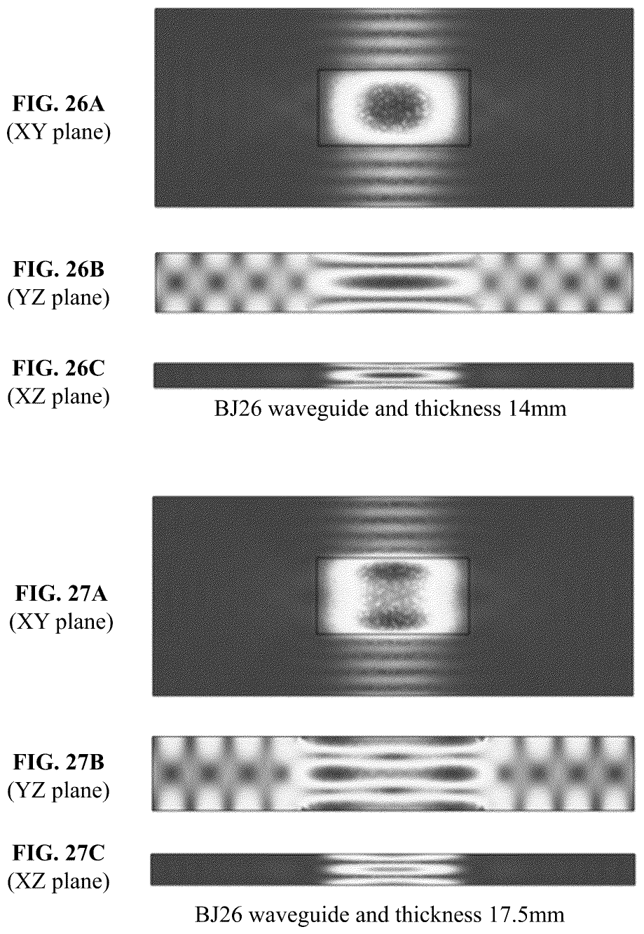

FIG. 26A-26C are schematic diagrams illustrating an exemplary influence of a thickness of a microwave resonant cavity of 14 mm (88% of a wavelength) on an electric field distribution when a 2450 MHz microwave uses a BJ26 waveguide according to some embodiments of the present disclosure, where FIG. 26A is an electric field distribution in an XY plane, FIG. 26B is an electric field distribution in a YZ plane, and FIG. 26C is an electric field distribution in an XZ plane.

In Embodiment 9, the electric field distribution was measured when the 2450 MHZ microwave uses the BJ26 waveguide and a thickness of the resonant cavity meets 80% to 95%, including the following operations.

In S1: The microwave frequency ƒ was determined as 2450 MHz.

In S2: The dielectric constants of the medium at the 2450 MHz frequency point were collected, and the temperature included 90° C. During the collecting, a medium temperature was raised to about 95° C. and the medium temperature was allowed to naturally decrease over time. A plurality of temperatures and the dielectric constants and dielectric losses at the plurality of temperatures were recorded.

In S3: The wavelength of the microwave in the purified water in the 2450 MHz frequency band was determined as 15.9 mm according to the formula (2).

In S4: According to the formation principle of the single-mode cavity and the application scenario of the actual microwave resonant cavity, the thickness of the microwave resonant cavity was set as the limiting factor. The thickness of the microwave resonant cavity was determined as wavelength*(80%-95%), which is 12.72 mm-15.11 mm.

In S5: The specification of the rectangular waveguide was selected as BJ26 according to the microwave frequency and GB/T 11450.2-1989.

In S6: The simple model including only the rectangular waveguide, the microwave window, and the microwave resonant cavity was established.

In S7: The parametric scan on the phase of the upper microwave source and the lower microwave source of the simple model was performed, and the microwave electric field distribution in the microwave resonant cavity was analyzed. For most microwave application scenarios, the microwave electric field should be distributed in the geometric center region of the microwave single-mode device, thereby facilitating the placement or removal of food. Therefore, when performing phase influence result determination, the dispersion, concentration, and electric field strength of the microwave electric field should be primarily studied. The specific operations for determining the phase influence are the same as those in the Embodiments 1.

In S8: The parametric scan on the length and the width of the microwave resonant cavity was performed; the electric field distribution and the reflection situation in the XY plane were observed. The length of the long side of the rectangular waveguide was set as 1 unit length a, and the length of the short side of the rectangular waveguide was set as 1 unit length b, and half of the wavelength (λ/2) of the microwave in the liquid medium at a certain frequency was defined as one unit, denoted by the letter c. In Embodiment 9, a was 86.36 mm, b was 43.18 mm, and c was 7.95 mm. The scan parameters are as shown in Table 7 below:

TABLE 7
Parametric scan settings for the length, the width, and
the thickness of microwave heating cavity in Embodiment 9

| Parameter | Parameter value | Parameter unit | |
|---|---|---|---|
| name | list | (mm) | Parameter content |
| Horn_ux | Range (1.0a, | Range (86.36, | Microwave heating |
| | 0.5a, 4.0a) | 43.18, 345.44) | cavity length |
| Horn_uy | Range (1.0b, | Range (43.18, | Microwave heating |
| | 0.25b, 2.5b) | 10.80, 107.95) | cavity width |
| Horn_uy | Range (1.0c, | Range (7.95, | Microwave heating |
| | 0.5c, 5.0c) | 3.98, 39.75) | cavity thickness |

FIG. 26 shows the electric field distribution of a 2450 MHz microwave using a BJ26 waveguide when the resonant cavity thickness is 14 mm (88% of the wavelength). In Embodiment 9, high electric field regions in the XY plane, YZ plane, and XZ plane all exist in the middle region of the resonant cavity. A relatively uniform and unified elliptical shape is presented. The above results indicate that a uniform microwave resonant cavity physical cavity size design may be achieved according to the technical means of the present disclosure.

### Comparative Example 9

FIG. 27A-27C are schematic diagrams illustrating an exemplary influence of a thickness of a microwave resonant cavity of 17.5 mm (110% of a wavelength) on an electric field distribution when a 2450 MHz microwave uses a BJ26 waveguide according to some embodiments of the present disclosure, where FIG. 27A is an electric field distribution in an XY plane, FIG. 27B is an electric field distribution in a YZ plane, and FIG. 27C is an electric field distribution in an XZ plane.

In Comparative Example 9, the electric field distribution was measured when the 2450 MHz microwave uses the BJ26 waveguide and the resonant cavity thickness does not meet 80% to 95%.

FIG. 27 shows the electric field distribution when a 2450 MHz microwave uses a BJ26 rectangular waveguide and the resonant cavity thickness is 17.5 mm (110%). In Comparative Example 9, the XY plane electric field has two elliptical high electric field regions that are about to separate, and there is still a relatively uniform higher electric field region in the middle. The YZ plane electric field distribution shows that the middle layer has a similar electric field distribution to the upper layer and the lower layer, and the microwave energy utilization rate is low at this time. The electric field distribution in the XZ plane also shows that the electric field strength of the middle layer is almost the same as that of the upper layer and the lower layer. About half of the microwave energy is used to heat the medium rather than the food, and about half of the energy is wasted at this time.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for description purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A uniform electric field cavity design method for a single-mode liquid microwave resonant cavity, wherein the uniform electric field cavity design method comprises:
S1: determining a microwave frequency ƒ;
S2: collecting dielectric constants of a liquid medium in an ƒ frequency band, wherein the ƒ frequency band is a frequency band range of the microwave frequency ƒ±20 MHz; during the collecting, raising a temperature of the liquid medium to 95±2° C. and allowing the temperature to naturally decrease over time; and recording a plurality of temperatures and the dielectric constants and dielectric losses at the plurality of temperatures;
S3: determining a wavelength of a microwave of the ƒ frequency band in the liquid medium according to a wavelength formula;
S4: determining a thickness of a microwave resonant cavity according to the wavelength of the microwave in the liquid medium in S3;
S5: selecting a specification of a rectangular waveguide according to the microwave frequency ƒ and GB/T 11450.2-1989;
S6: establishing a simple model including only the rectangular waveguide, a microwave window, and the microwave resonant cavity;
S7: performing a parametric scan on phases of an upper microwave source and a lower microwave source of the simple model, and analyzing a microwave electric field distribution in the microwave resonant cavity;
S8: performing a parametric scan on a length and a width of the microwave resonant cavity; and observing an electric field distribution and a reflection situation on an XY plane;
S9: determining a waveguide wavelength λg at the microwave frequency ƒ based on formula (3), and adding a rectangular waveguide with height λg/2 to one side of the microwave resonant cavity, wherein a microwave in the microwave resonant cavity changes by half a phase cycle (2*π);
$${λ}_{{gTE}_{10}} = \frac{λ}{\sqrt{1 - {( \frac{λ}{2 a} )}^{2}}} \qquad ( 3 )$$
S10: introducing a tapered waveguide based on the simple model; and
S11: performing a parametric scan on a microwave window length, a microwave window width, and a tapered waveguide height to complete an electric field cavity design.

2. The uniform electric field cavity design method according to claim 1, wherein in S2, during the temperature naturally decreases over time, the plurality of temperatures includes 90° C.

3. The uniform electric field cavity design method according to claim 1, wherein in S4, the thickness of the microwave resonant cavity is specified as λ*(80%-95%).

4. The uniform electric field cavity design method according to claim 1, wherein in S7, a dispersion, a concentration, and an electric field strength of a microwave electric field are primarily studied when determining a phase influence; and the determining the phase influence includes:
scanning an initial phase, setting the initial phase as prot, with a range of 0-2 π, and a scan step of π/4; and
setting an upper phase as prot+prot_1, and setting a lower phase as prot, wherein the upper phase prot+prot_1 has a scan range of 0-2 π and a scan step of π/4, and a scan range of the lower phase prot is set to 0-2 π.

5. The uniform electric field cavity design method according to claim 1, wherein in S8, a length of a long side of the rectangular waveguide is set to 1 unit length a, a length of a short side of the rectangular waveguide is set to 1 unit length b, and half of a wavelength (λ/2) of a microwave at a certain frequency in the liquid medium is defined as 1 unit, denoted by a letter c; and scan parameters are shown in Table 1:
TABLE 1
Parametric scan settings for the length, the width,
and the thickness of the microwave heating cavity

| Parameter Name | Parameter Value List | Parameter Content |
|---|---|---|
| Horn_ux | Range (1.0a, 0.5a, 4.0a) | microwave heating |
| | | cavity length |
| Horn_uy | Range (1.0b, 0.25b, 2.5b) | microwave heating |
| | | cavity width |
| Horn_uz | Range (1.0c, 0.5c, 5.0c) | microwave heating |
| | | cavity thickness |

6. The uniform electric field cavity design method according to claim 1, wherein in S10, a finite element principle or a finite-difference time-domain principle is used to establish a microwave heating module geometric model; a microwave field is added as a physical field based on Maxwell's equations; and a study type is set to frequency domain; a length of the rectangular waveguide is defined as a, and a width of the rectangular waveguide is defined as b.

7. The uniform electric field cavity design method according to claim 1, wherein in S11, a length of a long side of the rectangular waveguide is set to 1 unit length a, and a length of a short side of the rectangular waveguide is set to 1 unit length b; and S11 includes:
S111: setting the microwave window width to 1.0b, and performing a parametric scan on the microwave window length, wherein a parameter is defined as range (1.0a, 0.5a, 2.5a) and 1.75a, 2.15a, 2.25a, 2.35a;
S112: fixing the microwave window length, and performing a parametric scan on the microwave window width, wherein a parameter is set to range (0.5b, 0.1b, 1.5b);
S113: after the microwave window length and the microwave window width are determined, performing a parametric scan on the tapered waveguide height, wherein a parameter scan range and step are range (0.25a, 0.25a, 2a), and selecting the tapered waveguide height based on an electric field distribution and a reflection situation.

8. The uniform electric field cavity design method according to claim 1, further comprising S12:
determining an influence of a change in the microwave frequency ƒ on the electric field distribution to determine whether to use a single-frequency microwave or a band-frequency microwave;
determining an influence of a frequency fluctuation within the ƒ frequency band on the electric field distribution, wherein a determination basis is the electric field distribution and the reflection situation on the XY plane at Z=0;
wherein a size of the microwave resonant cavity is set to an optimal microwave resonant cavity x*y*z, a microwave window size is set to wx*wy, a horn height is set to hh, a frequency scan scheme is set to range (ƒ−20, 5, ƒ+20) in MHz.

9. The uniform electric field cavity design method according to claim 1, wherein the uniform electric field cavity design method is executed by a processor, and S7-S8 and S11 include:
performing a parametric scan on the simple model based on simulation parameters, the simulation parameters including a start value, an end value, and a scan step of the phases of the upper microwave source and the lower microwave source, the length of the microwave resonant cavity, the width of the microwave resonant cavity, the microwave window length, the microwave window width, and the tapered waveguide height.

10. The uniform electric field cavity design method according to claim 9, wherein the uniform electric field cavity design method further comprises:
generating at least one set of geometric parameters through a database based on a liquid type, a target temperature, and a dielectric constant and a dielectric loss corresponding to the target temperature; and
generating the simulation parameters based on the at least one set of geometric parameters.

11. The uniform electric field cavity design method according to claim 10, wherein the uniform electric field cavity design method further includes:
identifying at least one sensitive interval of at least one model parameter based on the at least one set of geometric parameters; and
adjusting the scan step based on the at least one sensitive interval.

12. The uniform electric field cavity design method according to claim 10, wherein the microwave resonant cavity is applied to a microwave single-mode device, the microwave single-mode device is configured with a weighing sensor, the weighing sensor is configured to obtain physical position information of a medium to be heated in the microwave resonant cavity, and the generating at least one set of geometric parameters through a database based on a liquid type, a target temperature, and a dielectric constant and a dielectric loss corresponding to the target temperature includes:
generating the at least one set of geometric parameters through the database based on the liquid type, the physical position information, the target temperature, and the dielectric constant and the dielectric loss corresponding to the target temperature.

13. The uniform electric field cavity design method according to claim 1, wherein the performing the parametric scan on the microwave window length, the microwave window width, and the tapered waveguide height in S11 includes:
performing a parametric scan on the microwave window length and the microwave window width to determine a plurality of candidate parameter combinations for the microwave window length and the microwave window width;
determining a preferred combination from the plurality of candidate parameter combinations through online physical verification based on the plurality of candidate parameter combinations; and
performing a parametric scan on the tapered waveguide height based on the preferred combination;
wherein the online physical verification includes: based on each candidate parameter combination of the plurality of candidate parameter combinations sent by a processor, a controller of a microwave single-mode device sending a voltage signal to a drive mechanism coupled to a variable aperture to control a length and a width of an opening of the microwave window to be adjusted to the microwave window length and the microwave window width corresponding to the candidate parameter combination.
